(19) United States
(12) Patent Application Publication
(10) Pub. No.: US 2024/0313657 A1
(43) Pub. Date: Sep. 19, 2024

(54) SWITCH-MODE POWER CONVERTERS WITH CONTROL OF TURNING ON AND OFF ONE TRANSISTOR BEFORE TURNING ON ANOTHER TRANSISTOR

(71) Applicant: ON-BRIGHT ELECTRONICS (SHANGHAI) CO., LTD., Shanghai (CN)

(72) Inventors: QIAN FANG, Shanghai (CN); YUN SUN, Shanghai (CN); TUOFU LIU, Shanghai (CN); XIUHONG ZHANG, Shanghai (CN); YUAN LIN, Shanghai (CN)

(21) Appl. No.: 18/601,567

(22) Filed: Mar. 11, 2024

(30) Foreign Application Priority Data
Mar. 14, 2023 (CN) 202310245305.8
Mar. 14, 2023 (CN) 202310246278.6

(51) Int. Cl. H02M 3/335; H02M 1/00; H02M 1/38

(52) U.S. Cl. CPC H02M 3/33523; H02M 1/0025; H02M 1/385

(57) ABSTRACT

Controller and method for a power converter. For example, a controller for a power converter includes: a first drive signal generator configured to generate a first drive signal to turn off a first transistor at a first time and turn on the first transistor at a second time, the first transistor being configured to receive an input voltage and related to a primary winding coupled to an auxiliary winding and a secondary winding, the secondary winding being related to an output voltage, the second time being later than the first time; a second drive signal generator configured to: generate a second drive signal to turn on a second transistor at a third time, the second transistor being coupled to the first transistor and related to the primary winding, the third time being later than the first time and being earlier than the second time.

### 1. CROSS-REFERENCES TO RELATED APPLICATIONS

This application claims priority to Chinese Patent Application No. 202310246278.6, filed Mar. 14, 2023, and Chinese Patent Application No. 202310245305.8, filed Mar. 14, 2023, both of these applications being incorporated by reference herein for all purposes.

### 2. FIELD OF THE DISCLOSURE

Certain embodiments of the present disclosure are directed to circuits. More particularly, some embodiments of the disclosure provide controllers and methods for control of turning on and off one transistor before turning on another transistor. Merely by way of example, some embodiments of the disclosure have been applied to asymmetrical half-bridge flyback switch-mode power converters. But it would be recognized that the disclosure has a much broader range of applicability.

### 3. BACKGROUND OF THE DISCLOSURE

The power converters can convert electric power from one form to another form. As an example, the electric power is transformed from alternate current (AC) to direct current (DC), from DC to AC, from AC to AC, or from DC to DC. Additionally, the power converters can convert the electric power from one voltage level to another voltage level. The power converters include linear converters and switch-mode converters. The switch-mode converters often are implemented with various architectures, such as the fly-back architecture, the buck architecture, and/or the boost architecture.

FIG. 1 is a simplified diagram showing a conventional asymmetrical half-bridge flyback switch-mode power converter. The asymmetrical half-bridge fly back switch-mode power converter 100 includes a primary winding 110, a secondary winding 112, transistors 120 and 130, a bridge rectifier 140, a diode 142, a resistor 144, and capacitors 150, 152 and 154. In some examples, each transistor of the transistors 120 and 130 is a metal-oxide-semiconductor field-effect transistor (MOSFET). For example, the transistor 120 includes a drain terminal 122, a gate terminal 124, and a source terminal 126, and the transistor 130) includes a drain terminal 132, a gate terminal 134, and a source terminal 136. As an example, the capacitor 152 includes capacitor terminals 156 and 158, and the diode 142 includes an anode 146 and a cathode 148.

As shown in FIG. 1, in an equivalent circuit, the primary winding 110 includes an inductor 116 with a primary inductance Lₚ, and the primary winding 110 also includes an inductor 118 with a leakage inductance Lᵣ. If a current 117 (e.g., I_{Lm}) flows from the capacitor terminal 158 to the primary winding 110, the current 117 has a positive value, and if the current 117 (e.g., I_{Lm}) flows from the primary winding 110 to the capacitor terminal 158, the current 117 has a negative value. The asymmetrical half-bridge fly back switch-mode power converter 100 receives an AC voltage 190 and generates an output voltage 192. The gate terminal 124 receives a drive voltage 125, and the gate terminal 134 receives a drive voltage 135. The source terminal 126 of the transistor 120 and the drain terminal 132 of the transistor 130 are connected to the capacitor terminal 156 (e.g., Cᵣ) of the capacitor 152 and biased to a voltage 127 (e.g., HB). The voltage 127 (e.g., HB) is the source voltage of the transistor 120 and the drain voltage of the transistor 130. The capacitor terminal 158 is connected to the primary winding 110. If a current 153 (e.g., I_{Lr}) flows to the capacitor terminal 156, the current 153 has a positive value, and if the current 153 (e.g., I_{Lr}) flows from the capacitor terminal 156, the current 153 has a negative value. Additionally, the anode 146 is connected to the secondary winding 112. If a current 143 (e.g., I_{Do}) flows to the anode 146, the current 143 has a positive value, and if the current 143 (e.g., I_{Do}) flows from the anode 146, the current 143 has a negative value. Also, the drain terminal 122 of the transistor 120 receives a voltage 151, and the source terminal 136 of the transistor 130 is biased to a ground voltage (e.g., 0) volts).

The asymmetrical half-bridge fly back switch-mode power converter 100 operates in a critical conduction mode (CRM) under a heavy load condition, and the asymmetrical half-bridge fly back switch-mode power converter 100 operates in a discontinuous conduction mode (DCM) under a light load condition. For example, the asymmetrical half-bridge flyback switch-mode power converter 100 operates in a cyclical manner, wherein each cycle of the discontinuous conduction mode (DCM) is followed by M cycles of the critical conduction mode (CRM) before another cycle of the discontinuous conduction mode (DCM), wherein M is a constant positive integer. As an example, the asymmetrical half-bridge flyback switch-mode power converter 100 operates continuously in the discontinuous conduction mode (DCM).

In some examples, through the resonance of the capacitor 152 (e.g., Cᵣ), an inductor 116 (e.g., with the primary inductance Lₚ), and the inductor 118 (e.g., with the leakage inductance Lᵣ), the transistor 120 (e.g., Q₁) achieves low-voltage switching and/or zero-voltage switching. In certain examples, through the resonance of the capacitor 152 (e.g., Cᵣ), the inductor 116 (e.g., with the primary inductance Lₚ), and the inductor 118 (e.g., with the leakage inductance Lᵣ), the transistor 130 (e.g., Q₂) achieves low-voltage switching and/or zero-voltage switching.

FIG. 2 shows simplified timing diagrams for the conventional asymmetrical half-bridge fly back switch-mode power converter 100 as shown in FIG. 1 in the critical conduction mode (CRM). The waveform 225 represents the drive voltage 125 as a function of time, the waveform 235 represents the drive voltage 135 as a function of time, the waveform 217 represents the current 117 as a function of time, the waveform 253 represents the current 153 as a function of time, the waveform 243 represents the current 143 as a function of time, and the waveform 227 represents the voltage 127 as a function of time.

At time t₀, the drive voltage 125 changes from a logic low level to a logic high level as shown by the waveform 225, and the transistor 120 becomes turned on. From time to to time t₁, the drive voltage 125 remains at the logic high level as shown by the waveform 225, and the transistor 120 remains turned on. For example, from time t₀ to time t₁, the current 153 increases with time, as shown by the waveform 253. As an example, during time to and time t₁, after the current 153 becomes positive, the current 153 flows to the capacitor terminal 156, and the voltage 151 charges the primary winding 110 through the capacitor 152.

At time t₁, the drive voltage 125 changes from the logic high level to the logic low level as shown by the waveform 225, and the transistor 120 becomes turned off. For example, at time t₁, the voltage 151 stops charging the primary winding 110. As an example, at time t₁, the current 153 reaches a current value 254 (e.g., Iₚ), wherein the current value 254 is positive.

From time t₁ to time t₂, the current 153 (e.g., I_{Lr}) is used to charge the parasitic capacitor of the transistor 120 and discharge the parasitic capacitor of the transistor 130, and the voltage 127 decreases with time as shown by the waveform 227.

At time t₂, the drive voltage 135 changes from the logic low level to the logic high level as shown by the waveform 235, and the transistor 130 becomes turned on. For example, at time t₂, the voltage 127 decreases to zero volts. As an example, at time t₂, the transistor 130 becomes turned on with low-voltage switching and/or zero-voltage switching.

From time t₂ to time t₃, the drive voltage 135 remains at the logic high level as shown by the waveform 235, and the transistor 130 remains turned on. In some examples, from time t₂ to time t₃, the current 143 (e.g., I_{Do}) has a positive value as shown by the waveform 243. For example, from time t₂ to time t₃, through the resonance of the capacitor 152 and the inductor 118 (e.g., with the leakage inductance Lᵣ), the current 153 (e.g., I_{Lr}) decreases to zero and then becomes negative as shown by the waveform 253. As an example, from time t₂ to time t₃, the current 117 (e.g., I_{Lm}) decreases linearly with time as shown by the waveform 217. At time t₃, the current 117 (e.g., I_{Lm}) becomes equal to the current 153 (e.g., I_{Lr}) as shown by the waveforms 217 and 253. As an example, at time t₃, the current 143 (e.g., I_{Do}) becomes equal to zero as shown by the waveform 243. From time t₃ to time t₄, the drive voltage 135 remains at the logic high level as shown by the waveform 235, and the transistor 130 remains turned on. For example, from time t₃ to time t₄, the capacitor 152 discharges through the transistor 130, and the current 153 flows from the capacitor terminal 156. As an example, from time t₃ to time t₄, the current 153 has a negative value that decreases with time as shown by the waveform 253.

At time t₄, the drive voltage 135 changes from the logic high level to the logic low level as shown by the waveform 235, and the transistor 130 becomes turned off. For example, at time t₄, the capacitor 152 stops discharging. As an example, at time t₄, the current 153 reaches a current value 255 (e.g., Iₙ), wherein the current value 255 is negative.

From time t₄ to time t₅, the current 153 (e.g., I_{Lr}) is used to discharge the parasitic capacitor of the transistor 120 and charge the parasitic capacitor of the transistor 130, and the voltage 127 increases with time as shown by the waveform 227. For example, from time t₄ to time t₅, the current 153 flows from the capacitor terminal 156. As an example, from time t₄ to time t₅, the current 153 has a negative value that increases with time as shown by the waveform 253.

At time t₅, the drive voltage 125 changes from the logic low level to the logic high level as shown by the waveform 225, and the transistor 120 becomes turned on. For example, at time t₅, the voltage 127 becomes equal to the voltage 151 as shown by the waveform 227. As an example, at time t₅, the transistor 120 becomes turned on with low-voltage switching and/or zero-voltage switching.

FIG. 3 shows simplified timing diagrams for the conventional asymmetrical half-bridge fly back switch-mode power converter 100 as shown in FIG. 1 in the discontinuous conduction mode (DCM). The waveform 425 represents the drive voltage 125 as a function of time, the waveform 435 represents the drive voltage 135 as a function of time, the waveform 417 represents the current 117 as a function of time, the waveform 453 represents the current 153 as a function of time, the waveform 443 represents the current 143 as a function of time, and the waveform 427 represents the voltage 127 as a function of time.

At time t₁₀, the drive voltage 125 changes from a logic low level to a logic high level as shown by the waveform 425, and the transistor 120 becomes turned on. From time t₁₀ to time t₁₁, the drive voltage 125 remains at the logic high level as shown by the waveform 425, and the transistor 120 remains turned on. For example, from time t₁₀ to time t₁₁, the current 153 increases with time, as shown by the waveform 453. As an example, during time t₁₀ and time t₁₁, after the current 153 becomes positive, the current 153 flows to the capacitor terminal 156, and the voltage 151 charges the primary winding 110 through the capacitor 152.

At time t₁₁, the drive voltage 125 changes from the logic high level to the logic low level as shown by the waveform 425, and the transistor 120 becomes turned off. For example, at time t₁₁, the voltage 151 stops charging the primary winding 110. As an example, at time t₁₁, the current 153 reaches a current value 454 (e.g., Iₚ), wherein the current value 454 is positive.

From time t₁₁ to time t₁₂, the current 153 (e.g., I_{Lr}) is used to charge the parasitic capacitor of the transistor 120 and discharge the parasitic capacitor of the transistor 130, and the voltage 127 decreases with time as shown by the waveform 427.

At time t₁₂, the drive voltage 135 changes from the logic low level to the logic high level as shown by the waveform 435, and the transistor 130 becomes turned on. For example, at time t₁₂, the voltage 127 decreases to zero volts. As an example, at time t₁₂, the transistor 130 becomes turned on with low-voltage switching and/or zero-voltage switching.

From time t₁₂ to time t₁₃, the drive voltage 135 remains at the logic high level as shown by the waveform 435, and the transistor 130 remains turned on. In some examples, from time t₁₂ to time t₁₃, the current 143 (e.g., I_{Do}) has a positive value as shown by the waveform 443. For example, from time t₁₂ to time t₁₃, through the resonance of the capacitor 152 and the inductor 118 (e.g., with the leakage inductance Lᵣ), the current 153 (e.g., I_{Lr}) decreases to zero and then becomes negative as shown by the waveform 453. As an example, from time t₁₂ to time t₁₃, the current 117 (e.g., I_{Lm}) decreases linearly with time as shown by the waveform 417.

At time t₁₃, the drive voltage 135 changes from the logic high level to the logic low level as shown by the waveform 435, and the transistor 130 becomes turned off. The length of time duration from time t₁₂ to time t₁₃ is a predetermined constant for the asymmetrical half-bridge fly back switch-mode power converter 100 as shown in FIG. 1. The current 117 (e.g., I_{Lm}) at time t₁₃ depends at least in part on the predetermined constant that is used as the length of time duration from time t₁₂ to time t₁₃, and the current 117 (e.g., I_{Lm}) at time t₁₃ is either equal to zero or is not equal to zero as shown by the waveform 417.

From time t₁₃ to time t₁₄, the resonance of the parasitic capacitor of the transistor 120, the parasitic capacitor of the transistor 130, the inductor 116 (e.g., with the primary inductance Lₚ), and the inductor 118 (e.g., with the leakage inductance Lᵣ) occurs. For example, through this resonance, the voltage 127 oscillates and reaches the voltage 151. As an example, through this resonance, the voltage 127 oscillates without reaching the voltage 151.

At time t₁₄, the drive voltage 135 changes from the logic low level to the logic high level as shown by the waveform 435, and the transistor 130 becomes turned on. From time t₁₄ to time tis, the drive voltage 135 remains at the logic high level as shown by the waveform 435, and the transistor 130 remains turned on. In some examples, from time t₁₄ to time t₁₅, the capacitor 152 is discharged through the transistor 130, and the current 153 (e.g., I_{Lr}) flows from the capacitor terminal 156. In certain examples, from time t₁₄ to time tis, the current 153 (e.g., I_{Lr}) has a negative value, and decreases with time as shown by the waveform 453.

At time t₁₅, the drive voltage 135 changes from the logic high level to the logic low level as shown by the waveform 435, and the transistor 130 becomes turned off. For example, at time t₁₅, the current 153 reaches a current value 455 (e.g., Iₙ_zvs), wherein the current value 455 is negative.

From time tis to time t₁₆, through the resonance of the parasitic capacitor of the transistor 120, the parasitic capacitor of the transistor 130, the inductor 116 (e.g., with the primary inductance Lₚ), and the inductor 118 (e.g., with the leakage inductance Lᵣ), the current 153 (e.g., I_{Lr}) is used to discharge the parasitic capacitor of the transistor 120 and charge the parasitic capacitor of the transistor 130, and the voltage 127 increases with time as shown by the waveform 427.

At time t₁₆, the drive voltage 125 changes from the logic low level to the logic high level as shown by the waveform 425, and the transistor 120 becomes turned on. For example, at time t₁₆, the voltage 127 becomes equal to the voltage 151 as shown by the waveform 427. As an example, at time t₁₆, the transistor 120 becomes turned on with low-voltage switching and/or zero-voltage switching.

Hence it is highly desirable to improve the technique for switch-mode power converters.

### 4. BRIEF SUMMARY OF THE DISCLOSURE

Certain embodiments of the present disclosure are directed to circuits. More particularly, some embodiments of the disclosure provide controllers and methods for control of turning on and off one transistor before turning on another transistor. Merely by way of example, some embodiments of the disclosure have been applied to asymmetrical half-bridge flyback switch-mode power converters. But it would be recognized that the disclosure has a much broader range of applicability.

According to certain embodiments, a controller for a power converter includes: a first drive signal generator configured to generate a first drive signal to turn off a first transistor at a first time and turn on the first transistor at a second time, the first transistor being configured to receive an input voltage and related to a primary winding coupled to an auxiliary winding and a secondary winding, the secondary winding being related to an output voltage, the second time being later than the first time: a second drive signal generator configured to: generate a second drive signal to turn on a second transistor at a third time, the second transistor being coupled to the first transistor and related to the primary winding, the third time being later than the first time and being earlier than the second time: change the second drive signal to turn off the second transistor at a fourth time, the fourth time being later than the third time and being earlier than the second time; and change the second drive signal to turn on the second transistor at a fifth time, the fifth time being later than the fourth time and being earlier than the second time: a first controller configured to generate a first control signal based at least in part on a first voltage related to the auxiliary winding and output the first control signal to the second drive signal generator: wherein the second drive signal generator is further configured to: in response to the first control signal changing from a first logic level to a second logic level, change the second drive signal to turn off the second transistor at a sixth time, the sixth time being later than the fifth time and being earlier than the second time.

According to some embodiments, a controller for a power converter includes: a first drive signal generator configured to generate a first drive signal to turn off a first transistor at a first time and turn on the first transistor at a second time, the first transistor being configured to receive an input voltage and related to a primary winding coupled to an auxiliary winding and a secondary winding, the secondary winding being related to an output voltage, the second time being later than the first time: a second drive signal generator configured to generate a second drive signal to turn on a second transistor at a third time and turn off the second transistor at a fourth time, the second transistor being coupled to the first transistor and related to the primary winding, the third time being later than the first time, the fourth time being later than the third time and being earlier than the second time: an enablement controller configured to generate an enablement control signal based at least in part on a first voltage related to the auxiliary winding and output the enablement control signal to the second drive signal generator; and a first controller configured to generate a first control signal based at least in part on a second voltage related to the output voltage and output the first control signal to the second drive signal generator: wherein the second drive signal generator is further configured to; in response to the first control signal changing from a first logic level to a second logic level when the enablement control signal is at a third logic level, change the second drive signal to turn on the second transistor at a fifth time, the fifth time being later than the fourth time and being earlier than the second time; and in response to the first control signal changing from the first logic level to the second logic level when the enablement control signal is at a fourth logic level, not change the second drive signal so that the second transistor remains being turned off from the fourth time to the second time; wherein: the first logic level and the second logic level are different; and the third logic level and the fourth logic level are different.

According to certain embodiments, a method for a power converter includes: generating a first drive signal to turn off a first transistor at a first time, the first transistor being configured to receive an input voltage and related to a primary winding coupled to an auxiliary winding and a secondary winding, the secondary winding being related to an output voltage: changing the first drive signal to turn on the first transistor at a second time, the second time being later than the first time: generating a second drive signal to turn on a second transistor at a third time, the second transistor being coupled to the first transistor and related to the primary winding, the third time being later than the first time and being earlier than the second time; changing the second drive signal to turn off the second transistor at a fourth time, the fourth time being later than the third time and being earlier than the second time; changing the second drive signal to turn on the second transistor at a fifth time, the fifth time being later than the fourth time and being earlier than the second time: generating a first control signal based at least in part on a first voltage related to the auxiliary winding; and in response to the first control signal changing from a first logic level to a second logic level, changing the second drive signal to turn off the second transistor at a sixth time, the sixth time being later than the fifth time and being earlier than the second time.

According to some embodiments, a method for a power converter includes: generating a first drive signal to turn off a first transistor at a first time, the first transistor being configured to receive an input voltage and related to a primary winding coupled to an auxiliary winding and a secondary winding, the secondary winding being related to an output voltage; changing the first drive signal to turn on the first transistor at a second time, the second time being later than the first time: generating a second drive signal to turn on a second transistor at a third time, the second transistor being coupled to the first transistor and related to the primary winding, the third time being later than the first time and being earlier than the second time: changing the second drive signal to turn off the second transistor at a fourth time, the fourth time being later than the third time and being earlier than the second time; generating an enablement control signal based at least in part on a first voltage related to the auxiliary winding: generating a first control signal based at least in part on a second voltage related to the output voltage; in response to the first control signal changing from a first logic level to a second logic level when the enablement control signal is at a third logic level, changing the second drive signal to turn on the second transistor at a fifth time, the fifth time being later than the fourth time and being earlier than the second time; and in response to the first control signal changing from the first logic level to the second logic level when the enablement control signal is at a fourth logic level, not changing the second drive signal so that the second transistor remains being turned off from the fourth time to the second time; wherein: the first logic level and the second logic level are different; and the third logic level and the fourth logic level are different.

Depending upon embodiment, one or more benefits may be achieved. These benefits and various additional objects, features and advantages of the present disclosure can be fully appreciated with reference to the detailed description and accompanying drawings that follow.

### 5. BRIEF DESCRIPTION OF THE DRAWINGS

FIG. 1 is a simplified diagram showing a conventional asymmetrical half-bridge flyback switch-mode power converter.

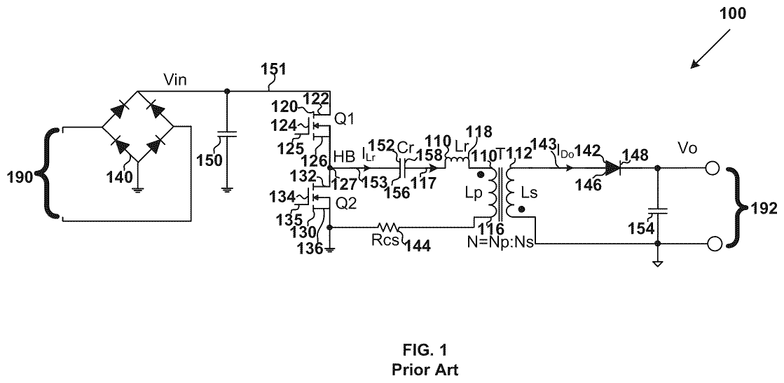

FIG. 2 shows simplified timing diagrams for the conventional asymmetrical half-bridge flyback switch-mode power converter as shown in FIG. 1 in the critical conduction mode (CRM).

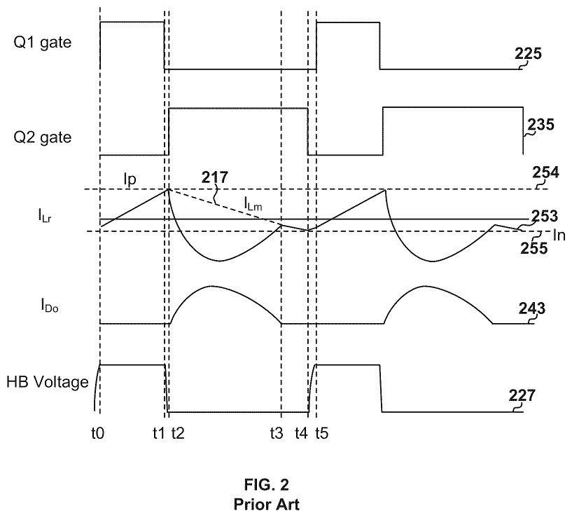

FIG. 3 shows simplified timing diagrams for the conventional asymmetrical half-bridge flyback switch-mode power converter as shown in FIG. 1 in the discontinuous conduction mode (DCM).

FIG. 4 is a simplified diagram showing an asymmetrical half-bridge flyback switch-mode power converter according to certain embodiments of the present disclosure.

FIG. 5 shows simplified timing diagrams for the asymmetrical half-bridge flyback switch-mode power converter as shown in FIG. 4 in the discontinuous conduction mode (DCM) with the mode and/or frequency control signal (e.g., DCM_on) changing from a logic low level to a logic high level when the turning-on enablement signal (e.g., T_{zvs}_ENA) is at a logic high level according to certain embodiment of the present disclosure.

FIG. 6 shows simplified timing diagrams for the asymmetrical half-bridge flyback switch-mode power converter as shown in FIG. 4 in the discontinuous conduction mode (DCM) with the mode and/or frequency control signal (e.g., DCM_on) changing from a logic low level to a logic high level when the turning-on enablement signal (e.g., T_{zvs}_ENA) is at a logic low level according to certain embodiment of the present disclosure.

FIG. 7 is a simplified diagram showing the turning-on enablement controller as part of the asymmetrical half-bridge fly back switch-mode power converter as shown in FIG. 4 according to certain embodiments of the present disclosure.

FIG. 8 is a simplified diagram showing the turning-off controller as part of the asymmetrical half-bridge flyback switch-mode power converter as shown in FIG. 4 according to some embodiments of the present disclosure.

FIG. 9 shows simplified timing diagrams for the asymmetrical half-bridge flyback switch-mode power converter as shown in FIG. 4 and FIG. 8 in the discontinuous conduction mode (DCM) with the mode and/or frequency control signal (e.g., DCM_on) changing from a logic low level to a logic high level when the turning-on enablement signal (e.g., T_{zvs}_ENA) is at a logic high level according to certain embodiment of the present disclosure.

FIG. 10 shows simplified timing diagrams for the asymmetrical half-bridge flyback switch-mode power converter as shown in FIG. 4 and FIG. 8 in the discontinuous conduction mode (DCM) with the mode and/or frequency control signal (e.g., DCM_on) changing from a logic low level to a logic high level when the turning-on enablement signal (e.g., T_{zvs}_ENA) is at a logic high level according to some embodiment of the present disclosure.

FIG. 11 shows simplified timing diagrams for the asymmetrical half-bridge fly back switch-mode power converter 300 as shown in FIG. 4 and FIG. 8 in the discontinuous conduction mode (DCM) with the mode and/or frequency control signal (e.g., DCM_on) changing from a logic low level to a logic high level when the turning-on enablement signal (e.g., T_{zvs}_ENA) is at a logic high level according to certain embodiment of the present disclosure.

FIG. 12 is a simplified diagram showing the turning-off controller as part of the asymmetrical half-bridge flyback switch-mode power converter as shown in FIG. 4 according to certain embodiments of the present disclosure.

### 6. DETAILED DESCRIPTION OF THE DISCLOSURE

Certain embodiments of the present disclosure are directed to circuits. More particularly, some embodiments of the disclosure provide controllers and methods for control of turning on and off one transistor before turning on another transistor. Merely by way of example, some embodiments of the disclosure have been applied to asymmetrical half-bridge fly back switch-mode power converters. But it would be recognized that the disclosure has a much broader range of applicability.

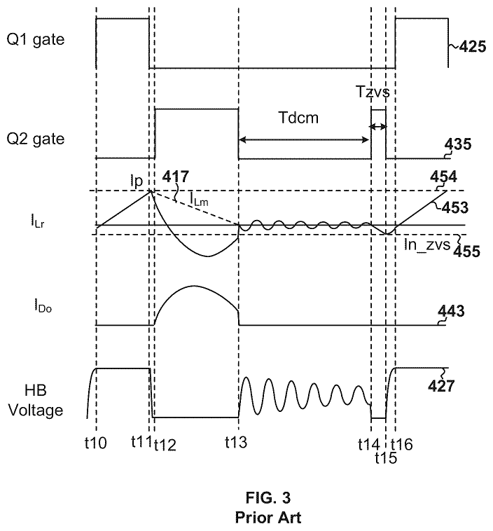

As shown in FIG. 3, when the conventional asymmetrical half-bridge fly back switch-mode power converter 100 operates in the discontinuous conduction mode (DCM), whether the voltage 127 becomes equal to zero volts and the transistor 130 realizes low-voltage switching and/or zero-voltage switching at time t₁₂ depends on the current value 454 (e.g., Iₚ) of the current 153 (e.g., I_{Lr}) at time t₁₁ when the transistor 120 becomes turned off according to certain embodiments. For example, if the current value 454 (e.g., Iₚ) is sufficiently large, the voltage 127 decrease to zero volts and the transistor 130 becomes turned on with low-voltage switching and/or zero-voltage switching at time t₁₂.

Also as shown in FIG. 3, when the conventional asymmetrical half-bridge fly back switch-mode power converter 100 operates in the discontinuous conduction mode (DCM), whether the voltage 127 becomes equal to the voltage 151 and the transistor 120 realizes low-voltage switching and/or zero-voltage switching at time t₁₆ depends on the current value 455 (e.g., Iₙ_zvs) of the current 153 (e.g., I_{Lr}) at time tis when the transistor 130 becomes turned off according to some embodiments. In certain examples, the current value 455 (e.g., Iₙ_zvs) is determined at least in part by the time duration (e.g., Tzvs) from time t₁₄ to time t₁₅. For example, if the time duration (e.g., Tzvs) from time t₁₄ to time t₁₅ is too short, the magnitude of the current value 455 (e.g., Iₙ_zvs) would be too small, so the energy for the resonance of the parasitic capacitor of the transistor 120, the parasitic capacitor of the transistor 130, the inductor 116 (e.g., with the primary inductance Lₚ), and the inductor 118 (e.g., with the leakage inductance Lᵣ) from time tis to time t₁₆ would be too low; causing the voltage 127 not able to reach the voltage 151 and the transistor 120 not able to become turned on with low-voltage switching and/or zero-voltage switching at time t₁₆. As an example, if the time duration (e.g., Tzvs) from time t₁₄ to time tis is too long, the magnitude of the current value 455 (e.g., Iₙ_zvs) would be too large, so the energy for the resonance of the parasitic capacitor of the transistor 120, the parasitic capacitor of the transistor 130, the inductor 116 (e.g., with the primary inductance Lₚ), and the inductor 118 (e.g., with the leakage inductance Lᵣ) from time t₁₅ to time t₁₆ would be more than enough for the voltage 127 to reach the voltage 151 and the transistor 120 to become turned on with low-voltage switching and/or zero-voltage switching at time t₁₆.

In some examples, if the energy for the resonance of the parasitic capacitor of the transistor 120, the parasitic capacitor of the transistor 130, the inductor 116 (e.g., with the primary inductance Lₚ), and the inductor 118 (e.g., with the leakage inductance Lᵣ) from time t₁₅ to time t₁₆ is more than enough for the voltage 127 to reach the voltage 151 and for the transistor 120 to become turned on with low-voltage switching and/or zero-voltage switching, the large resonance energy can cause larger energy loss during the resonance process. In certain examples, if the energy for the resonance of the parasitic capacitor of the transistor 120, the parasitic capacitor of the transistor 130, the inductor 116 (e.g., with the primary inductance Lₚ), and the inductor 118 (e.g., with the leakage inductance Lᵣ) from time tis to time t₁₆ is more than enough for the voltage 127 to reach the voltage 151 and for the transistor 120 to become turned on with low-voltage switching and/or zero-voltage switching, the larger magnitude of the current value 455 (e.g., Iₙ_zvs) needs the magnitude of the current value 454 (e.g., Iₚ) to also become larger in order to generate a constant output current for the conventional asymmetrical half-bridge fly back switch-mode power converter 100, causing the energy loss becomes larger when the transistor 120 becomes turned off.

In certain embodiments, when the conventional asymmetrical half-bridge fly back switch-mode power converter 100 operates in the discontinuous conduction mode (DCM), if the time duration (e.g., Tzvs) from time t₁₄ to time t₁₅ is too short, the transistor 120 is not able to become turned on with low-voltage switching and/or zero-voltage switching; if the time duration (e.g., Tzvs) from time t₁₄ to time tis is too long, the transistor 120 is able to become turned on with low-voltage switching and/or zero-voltage switching, but the energy loss becomes larger. In some embodiments, when the conventional asymmetrical half-bridge fly back switch-mode power converter 100 operates in the discontinuous conduction mode (DCM), the time duration (e.g., Tzvs) from time t₁₄ to time tis needs to be controlled to be just long enough for the transistor 120 to become turned on with low-voltage switching and/or zero-voltage switching.

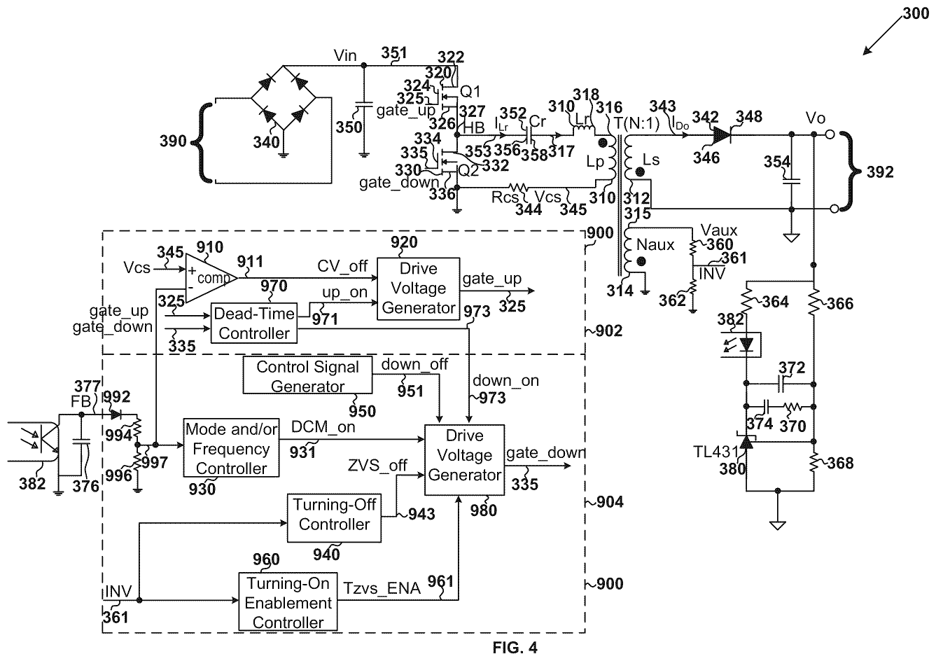

FIG. 4 is a simplified diagram showing an asymmetrical half-bridge fly back switch-mode power converter according to certain embodiments of the present disclosure. This diagram is merely an example, which should not unduly limit the scope of the claims. One of ordinary skill in the art would recognize many variations, alternatives, and modifications. The asymmetrical half-bridge flyback switch-mode power converter 300 includes a primary winding 310, a secondary winding 312, an auxiliary winding 314, transistors 320 and 330, a bridge rectifier 340, a diode 342, a resistor 344, capacitors 350, 352 and 354, resistors 360, 362, 364, 366, 368 and 370, capacitors 372, 374 and 376, a shunt regulator 380) (e.g., TL431), an optocoupler 382, and a controller 900. The controller 900 includes a comparator 910, a drive voltage generator 920, a mode and/or frequency controller 930, a turning-off controller 940, a control signal generator 950, a turning-on enablement controller 960, a dead-time controller 970, a drive voltage generator 980, a diode 992, and resistors 994 and 996. In some examples, each transistor of the transistors 320 and 330) is a metal-oxide-semiconductor field-effect transistor (MOSFET). For example, the transistor 320 includes a drain terminal 322, a gate terminal 324, and a source terminal 326, and the transistor 330 includes a drain terminal 332, a gate terminal 334, and a source terminal 336. As an example, the capacitor 352 (e.g., Cᵣ) includes capacitor terminals 356 and 358, and the diode 342 includes an anode 346 and a cathode 348. In certain examples, the primary winding 310, the secondary winding 312, and the auxiliary winding 314 are coupled to each other as parts of a transformer. Although the above has been shown using a selected group of components for the asymmetrical half-bridge flyback switch-mode power converter, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As shown in FIG. 4, in an equivalent circuit, the primary winding 310 includes an inductor 316 with a primary inductance Lₚ, and the primary winding 310 also includes an inductor 318 with a leakage inductance Lᵣ according to some embodiments. For example, if a current 317 (e.g., I_{Lm}) flows from the capacitor terminal 358 to the primary winding 310, the current 317 has a positive value. As an example, if the current 317 (e.g., I_{Lm}) flows from the primary winding 310 to the capacitor terminal 358, the current 317 has a negative value. In certain examples, the controller 900 includes a controller 902 for the transistor 320 and a controller 904 for the transistor 330. For example, the controller 902 for the transistor 320) includes the comparator 910, the drive voltage generator 920, and the dead-time controller 970. As an example, the controller 904 for the transistor 330 includes the mode and/or frequency controller 930, the turning-off controller 940, the control signal generator 950, the turning-on enablement controller 960, the drive voltage generator 980, the diode 992, and the resistors 994 and 996.

According to certain embodiments, the asymmetrical half-bridge flyback switch-mode power converter 300 receives an AC voltage 390 and generates an output voltage 392 according to some embodiments. For example, the gate terminal 324 receives a drive voltage 325 (e.g., a drive signal), and the gate terminal 334 receives a drive voltage 335 (e.g., a drive signal). As an example, the source terminal 326 of the transistor 320 and the drain terminal 332 of the transistor 330 are connected to the capacitor terminal 356 of the capacitor 352 and biased to a voltage 327. For example, the voltage 327 (e.g., HB) is the source voltage of the transistor 320 and the drain voltage of the transistor 330. In certain examples, the capacitor terminal 358 is connected to the primary winding 310. For example, if a current 353 flows to the capacitor terminal 356, the current 353 has a positive value, and if the current 353 flows from the capacitor terminal 356, the current 353 has a negative value. In some examples, the anode 346 is connected to the secondary winding 312. For example, if a current 343 flows to the anode 346, the current 343 has a positive value, and if the current 343 flows from the anode 346, the current 343 has a negative value. As an example, the drain terminal 322 of the transistor 320 receives a voltage 351 (e.g., an input voltage), and the source terminal 336 of the transistor 330 is biased to a ground voltage (e.g., 0 volts).

In some embodiments, the controller 900 receives a feedback voltage 377 and a current sensing voltage 345 and generate the drive voltage 325 based at least in part on the feedback voltage 377 and the current sensing voltage 345. For example, the drive voltage 325 is used to turn on and/or turn off the transistor 320. In certain examples, the feedback voltage 377 represents the output voltage 392, and the current sensing voltage 345 represents the current 353. In some examples, the drive voltage generator 920 (e.g., a drive signal generator) receives a turning-off control signal 911 (e.g., CV_off) and a turning-on control signal 971 (e.g., up_on) and generates the drive voltage 325 (e.g., a drive signal) based at least in part on the turning-off control signal 911 (e.g., CV_off) and the turning-on control signal 971 (e.g., up_on) to turn on and/or turn off the transistor 320. For example, in response to the turning-off control signal 911 (e.g., CV_off) changing from a logic low level to a logic high level, the drive voltage generator 920 changes the drive voltage 325 from a logic high level to a logic low level in order to turn off the transistor 320. As an example, in response to the turning-on control signal 971 (e.g., up_on) changing from a logic low level to a logic high level, the drive voltage generator 920 changes the drive voltage 325 from a logic low level to a logic high level in order to turn on the transistor 320.

In certain embodiments, the controller 900 also receives a voltage 361 and generates the drive voltage 335 based at least in part on the feedback voltage 377 and the voltage 361. As an example, the drive voltage 335 is used to turn on and/or turn off the transistor 330. In some examples, the voltage 361 represents a voltage 315 of the auxiliary winding 314. For example, one terminal of the resistor 360 and one terminal of the resistor 362 are connected to each other and are both biased to the voltage 361. As shown in FIG. 4, the drive voltage generator 980 (e.g., a drive signal generator) receives a mode and/or frequency control signal 931 (e.g., DCM_on), a turning-off control signal 943 (e.g., ZVS_off), a turning-off control signal 951 (e.g., down_off), a turning-on enablement signal 961 (e.g., T_{zvs}_ENA) and a turning-on control signal 973 (e.g., down_on), and generates the drive signal 335 (e.g., a drive signal) based at least in part on the mode and/or frequency control signal 931 (e.g., DCM_on), the turning-off control signal 943 (e.g., ZVS_off), the turning-off control signal 951 (e.g., down_off), the turning-on enablement signal 961 (e.g., T_{zvs}_ENA) and the turning-on control signal 973 (e.g., down_on) to turn on and/or turn off the transistor 330 according to certain embodiments.

According to some embodiments, the resistors 364, 366, 368 and 370, the capacitors 372, 374 and 376, the shunt regulator 380 (e.g., TL431), and the optocoupler 382 are used to generate the feedback voltage 377 based at least in part on the output voltage 392. For example, the feedback voltage 377 represents the output voltage 392. In certain examples, based at least in part on the feedback voltage 377, the diode 992 and the resistors 994 and 996 generate a voltage 997. For example, the feedback voltage 377 is reduced by the forward bias voltage of the diode 992 and then by the voltage divider that includes the resistors 994 and 996 in order to obtain the voltage 997. As an example, the change of the voltage 997 with time represents a difference between the output voltage 392 and a target voltage, wherein the target voltage is a voltage value to which the output voltage 392 is regulated. In some examples, the voltage 997 is received by the comparator 910, which also receives the current sensing voltage 345. For example, the comparator 910 generates the turning-off control signal 911 (e.g., CV_off) based at least in part on the current sensing voltage 345 and the voltage 997, and outputs the turning-off control signal 911 (e.g., CV_off) to the drive voltage generator 920. As an example, if the current sensing voltage 345 becomes larger than the voltage 997, the turning-off control signal 911 (e.g., CV_off) changes from a logic low level to a logic high level. In certain examples, in response to the turning-off control signal 911 (e.g., CV_off) changing from the logic low level to the logic high level, the drive voltage generator 920 changes the drive voltage 325 from the logic high level to the logic low level in order to turn off the transistor 320.

In certain embodiments, the dead-time controller 970 detects the drive voltage 325 changes from the logic high level to the logic low level, and then after a first predetermined dead-time duration (e.g., a first predetermined delay), changes the turning-on control signal 973 (e.g., down_on) from a logic low level to a logic high level to change the drive voltage 335 from a logic low level to a logic high level. For example, the turning-on control signal 973 (e.g., down_on) is at the logic high level and/or at the logic low level. As an example, in response to the turning-on control signal 973 (e.g., down_on) changing from the logic low level to the logic high level, the drive voltage generator 980 changes the drive voltage 335 from the logic low level to the logic high level in order to turn on the transistor 330. In some examples, the transistor 330 is turned on by the drive signal 335 the first predetermined dead-time duration (e.g., a first predetermined delay) after the transistor 320 is turned off. For example, during the first predetermined dead-time duration (e.g., a first predetermined delay), both transistors 320) and 330 are turned off.

In some embodiments, the dead-time controller 970) also detects the drive voltage 335 changes from the logic high level to the logic low level, and then after a second predetermined dead-time duration (e.g., a second predetermined delay), changes the turning-on control signal 971 (e.g., up_on) from the logic low level to the logic high level to change the drive voltage 325 from the logic low level to the logic high level. For example, the turning-on control signal 971 (e.g., up_on) is at the logic high level and/or at the logic low level. As an example, in response to at least the turning-on control signal 971 (e.g., up_on) changing from the logic low level to the logic high level, the drive voltage generator 920 changes the drive voltage 325 from the logic low level to the logic high level in order to turn on the transistor 320. In some examples, the transistor 320 is turned on by the drive signal 325 the second predetermined dead-time duration (e.g., a second predetermined delay) after the transistor 330 is turned off. For example, during the second predetermined dead-time duration (e.g., a second predetermined delay), both transistors 320 and 330 are turned off. As an example, the first predetermined dead-time duration (e.g., a first predetermined delay) and the second predetermined dead-time duration (e.g., a second predetermined delay) are equal or are not equal in length.

According to certain embodiments, the control signal generator 950 generates the turning-off control signal 951 (e.g., down_off). For example, the turning-off control signal 951 (e.g., down_off) is at the logic high level and/or at the logic low level. As an example, in response to the turning-off control signal 951 (e.g., down_off) changing from the logic low level to the logic high level, the drive voltage generator 980 changes the drive voltage 335 from the logic high level to the logic low level in order to turn off the transistor 330.

In some examples, the control signal generator 950 receives the turning-on control signal 973 (e.g., down_on) and generates the turning-off control signal 951 (e.g., down_off) based at least in part on the turning-on control signal 973 (e.g., down_on). For example, a predetermined time duration after the turning-on control signal 973 (e.g., down_on) changes from the logic low level to the logic high level to turn on the transistor 330, the control signal generator 950 changes the turning-off control signal 951 (e.g., down_off) from the logic low level to the logic high level to turn off the transistor 330.

In certain examples, the control signal generator 950 receives at least the voltage 361 (e.g., INV) and the voltage 997 and generates the turning-off control signal 951 (e.g., down_off) based at least in part on the voltage 361 (e.g., INV) and the voltage 997. For example, the control signal generator 950 is a demagnetization detector, which receives at least the voltage 361 (e.g., INV) and the voltage 997 to detect the end of a demagnetization process of the primary winding 310. As an example, at the end of the demagnetization process of the primary winding 310, the control signal generator 950 changes the turning-off control signal 951 (e.g., down_off) from the logic low level to the logic high level to turn off the transistor 330.

According to some embodiments, the turning-on enablement controller 960) receives the voltage 361 and generates the turning-on enablement signal 961 (e.g., T_{zvs}_ENA) based at least in part on the voltage 361. For example, the turning-on enablement signal 961 (e.g., T_{zvs}_ENA) is at the logic high level and/or at the logic low level.

In some embodiments, the mode and/or frequency controller 930 receives the voltage 997 and generates the mode and/or frequency control signal 931 (e.g., DCM_on) based at least in part on the voltage 997. In certain examples, the mode and/or frequency control signal 931 (e.g., DCM_on) is used to control the operation mode and/or the operation frequency of the asymmetrical half-bridge flyback switch-mode power converter 300. For example, the mode and/or frequency control signal 931 (e.g., DCM_on) is used to lower the operation frequency of the asymmetrical half-bridge fly back switch-mode power converter 300 if the load of the asymmetrical half-bridge flyback switch-mode power converter 300 becomes lighter. In some examples, the mode and/or frequency control signal 931 (e.g., DCM_on) is at the logic high level and/or at the logic low level.

According to certain embodiments, when the turning-on enablement signal 961 (e.g., T_{zvs}_ENA) is at the logic high level, in response to the mode and/or frequency control signal 931 (e.g., DCM_on) changing from the logic low level to the logic high level, the drive voltage generator 980 changes the drive voltage 335 from the logic low level to the logic high level in order to turn on the transistor 330.

According to some embodiments, the turning-off controller 940 receives the voltage 361 and generates the turning-off control signal 943 (e.g., ZVS_off) based at least in part on the voltage 361. For example, the turning-off control signal 943 (e.g., ZVS_off) is at the logic high level and/or at the logic low level. As an example, in response to the turning-off control signal 943 (e.g., ZVS_off) changing from the logic low level to the logic high level, the drive voltage generator 980 changes the drive voltage 335 from the logic high level to the logic low level in order to turn off the transistor 330. In certain examples, after the transistor 330 becomes turned off in response to the turning-off control signal 943 (e.g., ZVS_off) changing from the logic low level to the logic high level, the current 353 (e.g., I_{Lr}) is used to discharge the parasitic capacitor of the transistor 320 and charge the parasitic capacitor of the transistor 330, and the voltage 327 increases with time. For example, the voltage 327 increases to become equal to the voltage 351. As an example, the second predetermined dead-time duration (e.g., a second predetermined delay) after the transistor 330 becomes turned off in response to the turning-off control signal 943 (e.g., ZVS_off) changing from the logic low level to the logic high level, with the voltage 327 equal to the voltage 351, the drive voltage 325 changes from the logic low level to the logic high level and the transistor 320 becomes turned on with low-voltage switching and/or zero-voltage switching.

In certain embodiments, when the turning-on enablement signal 961 (e.g., T_{zvs}_ENA) is at the logic low level, in response to the mode and/or frequency control signal 931 (e.g., DCM_on) changing from the logic low level to the logic high level, the drive voltage generator 980 does not change the drive voltage 335 from the logic low level to the logic high level. In certain examples, after the transistor 330 becomes turned off in response to the turning-off control signal 951 (e.g., down_off) changing from the logic low level to the logic high level, through the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ), the voltage 327 oscillates. For example, the voltage 327 oscillates and reaches the voltage 351. As an example, the second predetermined dead-time duration (e.g., a second predetermined delay) after the mode and/or frequency control signal 931 (e.g., DCM_on) changes from the logic low level to the logic high level, with the voltage 327 equal to the voltage 351, the drive voltage 325 changes from the logic low level to the logic high level and the transistor 320 becomes turned on with low-voltage switching and/or zero-voltage switching.

In some embodiments, after the transistor 330 becomes turned off in response to the turning-off control signal 951 (e.g., down_off) changing from the logic low level to the logic high level, the resonance of the parasitic capacitor of the transistor 320, the parasitic capacitor of the transistor 330, the inductor 316 (e.g., with the primary inductance Lₚ), the inductor 318 (e.g., with the leakage inductance Lᵣ), and the capacitor 352 (e.g., Cᵣ) occurs. In certain examples, the capacitance of the capacitor 352 (e.g., Cᵣ) is much larger than the sum of the capacitance of the parasitic capacitor of the transistor 320 and the capacitance of the parasitic capacitor of the transistor 330, and the voltage drop between the capacitor terminals 356 and 358 of the capacitor 352 (e.g., Cᵣ) is equal to N×Vₒ, wherein Vₒ represents the output voltage 392, and N represents the turns ratio that is equal to the ratio of the number of turns in the primary winding 310 to the number of turns in the secondary winding 312.

For example, through the resonance of the parasitic capacitor of the transistor 320, the parasitic capacitor of the transistor 330, the inductor 316 (e.g., with the primary inductance Lₚ), the inductor 318 (e.g., with the leakage inductance Lᵣ), and the capacitor 352 (e.g., Cᵣ), the voltage 327 oscillates with an average value of N×Vₒ and an amplitude of N×Vₒ, wherein Vₒ represents the output voltage 392, and N represents the turns ratio that is equal to the ratio of the number of turns in the primary winding 310 to the number of turns in the secondary winding 312. As an example, the maximum value of the voltage 327 is equal to 2×N×Vₒ, and the minimum value of the voltage 327 is equal to zero. In some examples, if the voltage 351 is smaller than 2×N×Vₒ, the voltage 327 can reach the voltage 351 and the transistor 320 can become turned on with low-voltage switching and/or zero-voltage switching, when the turning-on enablement signal 961 (e.g., T_{zvs}_ENA) is at the logic low level.

As shown in FIG. 4, the dead-time controller 970 generates the turning-on control signal 971 (e.g., up_on) and the turning-on control signal 973 (e.g., down_on) according to some embodiments. In certain examples, the turning-on control signal 971 (e.g., up_on) is received by the drive voltage generator 920, and the turning-on control signal 973 (e.g., down_on) is received by the drive voltage generator 980. For example, in response to the turning-on control signal 971 (e.g., up_on) changing from the logic low level to the logic high level, the drive voltage generator 920 changes the drive voltage 325 from the logic low level to the logic high level in order to turn on the transistor 320. As an example, in response to the turning-on control signal 973 (e.g., down_on) changing from the logic low level to the logic high level, the drive voltage generator 980 changes the drive voltage 335 from the logic low level to the logic high level in order to turn on the transistor 330.

In certain embodiments, after the drive voltage 325 changes from the logic low level to the logic high level and the transistor 320 becomes turned on, the voltage 351 charges the primary winding 310 through the capacitor 352 and the current 353 flows to the capacitor terminal 356 with a positive value that increases with time. For example, when the positive value of the current 353 increases with time, the current sensing voltage 345 also increases with time. As an example, if the current sensing voltage 345 becomes larger than the voltage 997, the drive voltage 325 changes from the logic high level to the logic low level to turn off the transistor 320. In some examples, after the transistor 320 becomes turned off, the primary winding 310 is used to discharge the parasitic capacitor of the transistor 330 and charge the parasitic capacitor of the transistor 320, and the voltage 327 decreases with time. For example, the voltage 327 decreases to zero volts. As an example, the first predetermined dead-time duration (e.g., a first predetermined delay) after the transistor 320 becomes turned off, with the voltage 327 at zero volts, the drive voltage 335 changes from the logic low level to the logic high level and the transistor 330 becomes turned on with low-voltage switching and/or zero-voltage switching.

In some embodiments, the control signal generator 950) determines when to change the turning-off control signal 951 (e.g., down_off) from the logic low level to the logic high level in order to turn off the transistor 330. For example, after the transistor 330 becomes turned off, through the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ), the voltage 327 oscillates.

As shown in FIG. 4, the controller 902 for the transistor 320 uses the current sensing voltage 345, the voltage 997, and the drive voltage 335 to generate the drive voltage 325 in order to turn on and/or turn off the transistor 320, and the controller 904 for the transistor 330 uses the voltage 361, the voltage 997, and the drive voltage 325 to generate the drive voltage 335 in order to turn on and/or turn off the transistor 330 according to certain embodiments.

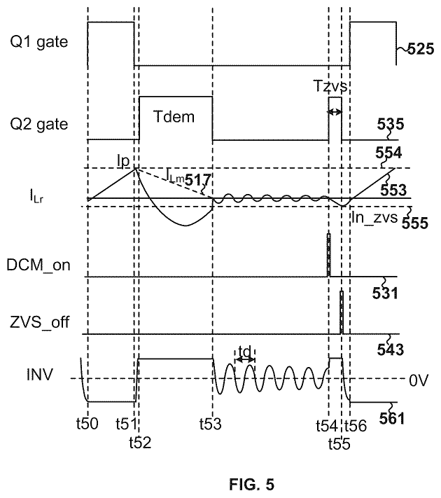

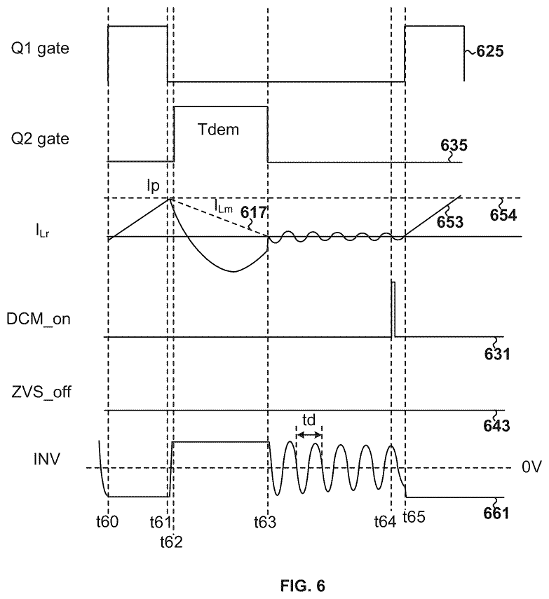

According to some embodiments, the asymmetrical half-bridge fly back switch-mode power converter 300 operates in a critical conduction mode (CRM) under a heavy load condition, and the asymmetrical half-bridge flyback switch-mode power converter 300 operates in a discontinuous conduction mode (DCM) under a light load condition. For example, the asymmetrical half-bridge fly back switch-mode power converter 300 operates in a discontinuous conduction mode (DCM) as shown in FIG. 5, wherein the mode and/or frequency control signal 931 (e.g., DCM_on) changes from the logic low level to the logic high level when the turning-on enablement signal 961 (e.g., T_{zvs}_ENA) is at the logic high level. As an example, the asymmetrical half-bridge flyback switch-mode power converter 300 operates in a discontinuous conduction mode (DCM) as shown in FIG. 6, wherein the mode and/or frequency control signal 931 (e.g., DCM_on) changes from the logic low level to the logic high level when the turning-on enablement signal 961 (e.g., T_{zvs}_ENA) is at the logic low level.

FIG. 5 shows simplified timing diagrams for the asymmetrical half-bridge flyback switch-mode power converter 300 as shown in FIG. 4 in the discontinuous conduction mode (DCM) with the mode and/or frequency control signal 931 (e.g., DCM_on) changing from a logic low level to a logic high level when the turning-on enablement signal 961 (e.g., T_{zvs}_ENA) is at a logic high level according to certain embodiment of the present disclosure. These diagrams are merely examples, which should not unduly limit the scope of the claims. One of ordinary skill in the art would recognize many variations, alternatives, and modifications. The waveform 525 represents the drive voltage 325 as a function of time, the waveform 535 represents the drive voltage 335 as a function of time, the waveform 517 represents the current 317 as a function of time, the waveform 553 represents the current 353 as a function of time, the waveform 531 represents the mode and/or frequency control signal 931 (e.g., DCM_on) as a function of time, the waveform 543 represents the turning-off control signal 943 (e.g., ZVS_off) as a function of time, and the waveform 561 represents the voltage 361 as a function of time.

At time t₅₀, the drive voltage 325 changes from a logic low level to a logic high level as shown by the waveform 525, and the transistor 320 becomes turned on according to some embodiments. For example, at time t₅₀, the turning-on control signal 971 (e.g., up_on) changes from the logic low level to the logic high level, and in response, the drive voltage generator 920 changes the drive voltage 325 from the logic low level to the logic high level in order to turn on the transistor 320. As an example, at time t₅₀, the drive voltage 335 is at the logic low level as shown by the waveform 535, and the transistor 330 is turned off.

From time t₅₀ to time t₅₁, the drive voltage 325 remains at the logic high level as shown by the waveform 525, and the transistor 320 remains turned on according to certain embodiments. For example, from time t₅₀ to time t₅₁, the current 353 increases with time, as shown by the waveform 553. As an example, from time t₅₀ to time t₅₁, the drive voltage 335 remains at the logic low level as shown by the waveform 535, and the transistor 330 remains turned off. In some examples, from time t₅₀ to time t₅₁, the current 353 increases with time, as shown by the waveform 553. For example, from time t₅₀ to time t₅₁, the current sensing voltage 345 also increases with time.

At time t₅₁, the drive voltage 325 changes from the logic high level to the logic low level as shown by the waveform 525, and the transistor 320 becomes turned off according to some embodiments. For example, at time t₅₁, the turning-off control signal 911 (e.g., CV_off) changes from the logic low level to the logic high level, and in response, the drive voltage generator 920 changes the drive voltage 325 from the logic high level to the logic low level in order to turn off the transistor 320. As an example, at time t₅₁, the drive voltage 335 is at the logic low level as shown by the waveform 535, and the transistor 330 is turned off. In certain examples, at time t₅₁, the current 353 reaches a current value 554 (e.g., Iₚ), wherein the current value 554 is positive.

From time t₅₁ to time t₅₂, the drive voltage 325 remains at the logic low level as shown by the waveform 525, and the drive voltage 335 remains at the logic low level as shown by the waveform 535 according to certain embodiments. For example, from time t₅₁ to time t₅₂, the transistor 320 remains turned off, and the transistor 330 also remains turned off. As an example, the time duration from time t₅₁ to time t₅₂ is equal to the first predetermined dead-time duration (e.g., a first predetermined delay) as determined by the dead-time controller 970. In some examples, from time t₅₁ to time t₅₂, the current 353 (e.g., I_{Lr}) is used to discharge the parasitic capacitor of the transistor 330 and charge the parasitic capacitor of the transistor 320. For example, from time t₅₁ to time t₅₂, the voltage 327 decreases with time.

At time t₅₂, the drive voltage 335 changes from the logic low level to the logic high level as shown by the waveform 535, and the transistor 330 becomes turned on according to some embodiments. For example, at time t₅₂, the turning-on control signal 973 (e.g., down_on) changes from the logic low level to the logic high level, and in response, the drive voltage generator 980 changes the drive voltage 335 from the logic low level to the logic high level in order to turn on the transistor 330. As an example, at time t₅₂, the drive voltage 325 is at the logic low level as shown by the waveform 525, and the transistor 320 is turned off. In certain examples, at time t₅₂, the voltage 327 reached zero volts. For example, at time t₅₂, the transistor 330 becomes turned on with low-voltage switching and/or zero-voltage switching.

From time t₅₂ to time t₅₃, the drive voltage 335 remains at the logic high level as shown by the waveform 535, and the transistor 330 remains turned on according to certain embodiments. For example, from time t₅₂ to time t₅₃, the drive voltage 325 remains at the logic low level as shown by the waveform 525, and the transistor 320 remains turned off. As an example, from time t₅₂ to time t₅₃, through the resonance of the capacitor 352 and the inductor 318 (e.g., with the leakage inductance Lᵣ), the current 353 (e.g., I_{Lr}) decreases to zero and then becomes negative as shown by the waveform 553. In some examples, from time t₅₂ to time t₅₃, the current 353 (e.g., I_{Lr}) decreases to zero and then becomes negative as shown by the waveform 553. In certain examples, from time t₅₂ to time t₅₃, the current 317 (e.g., I_{Lm}) decreases linearly with time as shown by the waveform 517.

At time t₅₃, the drive voltage 335 changes from the logic high level to the logic low level as shown by the waveform 535, and the transistor 330 becomes turned off according to some embodiments. For example, at time t₅₃, the turning-off control signal 951 (e.g., down_off) changes from the logic low level to the logic high level, and in response, the drive voltage generator 980 changes the drive voltage 335 from the logic high level to the logic low level in order to turn off the transistor 330. As an example, at time t₅₃, the drive voltage 325 is at the logic low level as shown by the waveform 525, and the transistor 320 is turned off.

In some examples, the length of time duration from time t₅₂ to time t₅₃ is a predetermined constant for the asymmetrical half-bridge fly back switch-mode power converter 300 as shown in FIG. 4. For example, the current 317 (e.g., I_{Lm}) at time t₅₃ depends at least in part on the predetermined constant that is used as the length of time duration from time t₅₂ to time t₅₃, and the current 317 (e.g., I_{Lm}) at time t₅₃ is either equal to zero or is not equal to zero as shown by the waveform 517.

In certain examples, at time t₅₃, the demagnetization process for the primary winding 310 ends, and the current 317 (e.g., I_{Lm}) decreases to zero as shown by the waveform 517. For example, the time duration from time t₅₂ to time t₅₃ represents the demagnetization period for the primary winding 310. As an example, time t₅₂ is the beginning of the demagnetization period for the primary winding 310, and time t₅₃ is the end of the demagnetization period for the primary winding 310.

From time t₅₃ to time t₅₄, the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ) occurs, as shown by the waveform 561 according to certain embodiments. For example, from time t₅₃ to time t₅₄, the voltage 327 oscillates without reaching the voltage 351. As an example, from time t₅₃ to time t₅₄, the resonance period is equal to T_{d}, as shown by the waveform 561.

At time t₅₄, the drive voltage 335 changes from the logic low level to the logic high level as shown by the waveform 535, and the transistor 330 becomes turned on according to some embodiments. For example, at time t₅₄, the mode and/or frequency control signal 931 (e.g., DCM_on) changes from the logic low level to the logic high level when the turning-on enablement signal 961 (e.g., T_{zvs}_ENA) is at the logic high level, and in response, the drive voltage generator 980 changes the drive voltage 335 from the logic low level to the logic high level in order to turn on the transistor 330. As an example, at time t₅₄, the drive voltage 325 is at the logic low level as shown by the waveform 525, and the transistor 320 is turned off.

From time t₅₄ to time t₅₅, the drive voltage 335 remains at the logic high level as shown by the waveform 535, and the transistor 330 remains turned on according to certain embodiments. For example, from time t₅₄ to time t₅₅, the drive voltage 325 remains at the logic low level as shown by the waveform 525, and the transistor 320 remains turned off. In some examples, from time t₅₄ to time t₅₅, the current 353 (e.g., I_{Lr}) has a negative value, and decreases with time as shown by the waveform 553. For example, from time t₅₄ to time t₅₅, the current 353 (e.g., I_{Lr}) flows from the capacitor terminal 356.

At time t₅₅, the drive voltage 335 changes from the logic high level to the logic low level as shown by the waveform 535, and the transistor 330 becomes turned off according to some embodiments. For example, at time t₅₅, the turning-off control signal 943 (e.g., ZVS_off) changes from the logic low level to the logic high level, and in response, the drive voltage generator 980 changes the drive voltage 335 from the logic high level to the logic low level in order to turn off the transistor 330. As an example, at time t₅₅, the drive voltage 325 is at the logic low level as shown by the waveform 525, and the transistor 320 is turned off. In certain embodiments, at time t₅₅, the current 353 reaches a current value 555 (e.g., Iₙ_zvs), wherein the current value 555 is negative.

From time t₅₅ to time t₅₆, the drive voltage 325 remains at the logic low level as shown by the waveform 525, and the drive voltage 335 remains at the logic low level as shown by the waveform 535 according to certain embodiments. For example, from time t₅₅ to time t₅₆, the transistor 320 remains turned off, and the transistor 330 also remains turned off. As an example, the time duration from time t₅₅ to time t₅₆ is equal to the second predetermined dead-time duration (e.g., a second predetermined delay) as determined by the dead-time controller 970. In some examples, from time t₅₅ to time t₅₆, through the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ), the current 153 (e.g., I_{Lr}) is used to discharge the parasitic capacitor of the transistor 120 and charge the parasitic capacitor of the transistor 130, and the voltage 127 increases with time.

At time t₅₆, the drive voltage 325 changes from the logic low level to the logic high level as shown by the waveform 525, and the transistor 320 becomes turned on according to some embodiments. For example, at time t₅₆, the turning-on control signal 971 (e.g., up_on) changes from the logic low level to the logic high level, and in response, the drive voltage generator 920 changes the drive voltage 325 from the logic low level to the logic high level in order to turn on the transistor 320. As an example, at time t₅₆, the drive voltage 335 is at the logic low level as shown by the waveform 535, and the transistor 330 is turned off. In certain examples, at time t₅₆, the voltage 327 becomes equal to the voltage 351. As an example, at time t₅₆, the transistor 320 becomes turned on with low-voltage switching and/or zero-voltage switching.

As mentioned above and further emphasized here, the timing diagrams as shown in FIG. 5 are merely examples, which should not unduly limit the scope of the claims. One of ordinary skill in the art would recognize many variations, alternatives, and modifications. For example, at time t₅₂, the voltage 327 becomes close to but is still larger than zero volts, and the transistor 330 becomes turned on with low-voltage switching, wherein the difference between the voltage 327 and the zero volts is small. As an example, at time t₅₆, the voltage 327 becomes close to but is still smaller than the voltage 351, and the transistor 320 becomes turned on with low-voltage switching, wherein the difference between the voltage 327 and the voltage 351 is small.

FIG. 6 shows simplified timing diagrams for the asymmetrical half-bridge fly back switch-mode power converter 300 as shown in FIG. 4 in the discontinuous conduction mode (DCM) with the mode and/or frequency control signal 931 (e.g., DCM_on) changing from a logic low level to a logic high level when the turning-on enablement signal 961 (e.g., T_{zvs}_ENA) is at a logic low level according to certain embodiment of the present disclosure. These diagrams are merely examples, which should not unduly limit the scope of the claims. One of ordinary skill in the art would recognize many variations, alternatives, and modifications. The waveform 625 represents the drive voltage 325 as a function of time, the waveform 635 represents the drive voltage 335 as a function of time, the waveform 617 represents the current 317 as a function of time, the waveform 653 represents the current 353 as a function of time, the waveform 631 represents the mode and/or frequency control signal 931 (e.g., DCM_on) as a function of time, the waveform 643 represents the turning-off control signal 943 (e.g., ZVS_off) as a function of time, and the waveform 661 represents the voltage 361 as a function of time.

At time t₆₀, the drive voltage 325 changes from a logic low level to a logic high level as shown by the waveform 625, and the transistor 320 becomes turned on according to some embodiments. For example, at time t₆₀, the turning-on control signal 971 (e.g., up_on) changes from the logic low level to the logic high level, and in response, the drive voltage generator 920 changes the drive voltage 325 from the logic low level to the logic high level in order to turn on the transistor 320. As an example, at time t₆₀, the drive voltage 335 is at the logic low level as shown by the waveform 635, and the transistor 330 is turned off. In certain examples, at time t₆₀, the turning-off control signal 943 (e.g., ZVS_off) is at the logic low level as shown by the waveform 643.

From time t₆₀ to time t₆₁, the drive voltage 325 remains at the logic high level as shown by the waveform 625, and the transistor 320 remains turned on according to certain embodiments. For example, from time t₆₀ to time t₆₁, the current 353 increases with time, as shown by the waveform 653. As an example, from time t₆₀ to time t₆₁, the drive voltage 335 remains at the logic low level as shown by the waveform 635, and the transistor 330 remains turned off. In some examples, from time t₆₀ to time t₆₁, the current 353 increases with time, as shown by the waveform 653. For example, from time t₆₀ to time t₆₁, the current sensing voltage 345 also increases with time. In certain examples, from time t₆₀ to time t₆₁, the turning-off control signal 943 (e.g., ZVS_off) remains at the logic low level as shown by the waveform 643.

At time t₆₁, the drive voltage 325 changes from the logic high level to the logic low level as shown by the waveform 625, and the transistor 320 becomes turned off according to some embodiments. For example, at time t₆₁, the turning-off control signal 911 (e.g., CV_off) changes from the logic low level to the logic high level, and in response, the drive voltage generator 920 changes the drive voltage 325 from the logic high level to the logic low level in order to turn off the transistor 320. As an example, at time t₆₁, the drive voltage 335 is at the logic low level as shown by the waveform 635, and the transistor 330 is turned off. In certain examples, at time t₆₁, the current 353 reaches a current value 654 (e.g., Iₚ), wherein the current value 654 is positive. In some examples, at time t₆₁, the turning-off control signal 943 (e.g., ZVS_off) is at the logic low level as shown by the waveform 643.

From time t₆₁ to time t₆₂, the drive voltage 325 remains at the logic low level as shown by the waveform 625, and the drive voltage 335 remains at the logic low level as shown by the waveform 635 according to certain embodiments. For example, from time t₆₁ to time t₆₂, the transistor 320 remains turned off, and the transistor 330 also remains turned off. As an example, the time duration from time t₆₁ to time t₆₂ is equal to the first predetermined dead-time duration (e.g., a first predetermined delay) as determined by the dead-time controller 970. In some examples, from time t₆₁ to time t₆₂, the current 353 (e.g., I_{Lr}) is used to discharge the parasitic capacitor of the transistor 330 and charge the parasitic capacitor of the transistor 320. For example, from time t₆₁ to time t₆₂, the voltage 327 decreases with time. In certain examples, from time t₆₁ to time t₆₂, the turning-off control signal 943 (e.g., ZVS_off) remains at the logic low level as shown by the waveform 643.

At time t₆₂, the drive voltage 335 changes from the logic low level to the logic high level as shown by the waveform 635, and the transistor 330 becomes turned on according to some embodiments. For example, at time t₆₂, the turning-on control signal 973 (e.g., down_on) changes from the logic low level to the logic high level, and in response, the drive voltage generator 980 changes the drive voltage 335 from the logic low level to the logic high level in order to turn on the transistor 330. As an example, at time t₆₂, the drive voltage 325 is at the logic low level as shown by the waveform 625, and the transistor 320 is turned off. In certain examples, at time t₆₂, the voltage 327 reached zero volts. For example, at time t₆₂, the transistor 330 becomes turned on with low-voltage switching and/or zero-voltage switching. In some examples, at time t₆₂, the turning-off control signal 943 (e.g., ZVS_off) is at the logic low level as shown by the waveform 643.

From time t₆₂ to time t₆₃, the drive voltage 335 remains at the logic high level as shown by the waveform 635, and the transistor 330 remains turned on according to certain embodiments. For example, from time t₆₂ to time t₆₃, the drive voltage 325 remains at the logic low level as shown by the waveform 625, and the transistor 320 remains turned off. As an example, from time t₆₂ to time t₆₃, through the resonance of the capacitor 352 and the inductor 318 (e.g., with the leakage inductance Lᵣ), the current 353 (e.g., I_{Lr}) decreases to zero and then becomes negative as shown by the waveform 653. In some examples, from time t₆₂ to time t₆₃, the current 353 (e.g., I_{Lr}) decreases to zero and then becomes negative as shown by the waveform 653. In certain examples, from time t₆₂ to time t₆₃, the current 317 (e.g., I_{Lm}) decreases linearly with time as shown by the waveform 617. In some examples, from time t₆₂ to time t₆₃, the turning-off control signal 943 (e.g., ZVS_off) remains at the logic low level as shown by the waveform 643.

At time t₆₃, the drive voltage 335 changes from the logic high level to the logic low level as shown by the waveform 635, and the transistor 330 becomes turned off according to some embodiments. For example, at time t₆₃, the turning-off control signal 951 (e.g., down_off) changes from the logic low level to the logic high level, and in response, the drive voltage generator 980 changes the drive voltage 335 from the logic high level to the logic low level in order to turn off the transistor 330. As an example, at time t₆₃, the drive voltage 325 is at the logic low level as shown by the waveform 525, and the transistor 320 is turned off.

In some examples, the length of time duration from time t₆₂ to time t₆₃ is a predetermined constant for the asymmetrical half-bridge fly back switch-mode power converter 300 as shown in FIG. 4. For example, the current 317 (e.g., I_{Lm}) at time t₆₃ depends at least in part on the predetermined constant that is used as the length of time duration from time t₆₂ to time t₆₃, and the current 317 (e.g., I_{Lm}) at time t₆₃ is either equal to zero or is not equal to zero as shown by the waveform 617.

In certain examples, at time t₆₃, the demagnetization process for the primary winding 310 ends, and the current 317 (e.g., I_{Lm}) decreases to zero as shown by the waveform 617. For example, the time duration from time t₆₂ to time t₆₃ represents the demagnetization period for the primary winding 310. As an example, time t₆₂ is the beginning of the demagnetization period for the primary winding 310, and time t₆₃ is the end of the demagnetization period for the primary winding 310. In some examples, at time t₆₃, the turning-off control signal 943 (e.g., ZVS_off) is at the logic low level as shown by the waveform 643.

From time t₆₃ to time t₆₄, the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ) occurs, as shown by the waveform 661 according to certain embodiments. For example, from time t₆₃ to time t₆₄, the voltage 327 oscillates and reaches the voltage 351. As an example, from time t₆₃ to time t₆₄, the resonance period is equal to T_{d}, as shown by the waveform 661. In some examples, from time t₆₃ to time t₆₄, the turning-off control signal 943 (e.g., ZVS_off) remains at the logic low level as shown by the waveform 643.

At time t₆₄, the drive voltage 335 does not change from the logic low level to the logic high level as shown by the waveform 535, and the transistor 330 does not become turned on according to some embodiments. For example, at time t₆₄, the mode and/or frequency control signal 931 (e.g., DCM_on) changes from the logic low level to the logic high level when the turning-on enablement signal 961 (e.g., T_{zvs}_ENA) is at the logic low level, and in response, the drive voltage generator 980) does not change the drive voltage 335 from the logic low level to the logic high level. As an example, at time t₆₄, the drive voltage 335 is at the logic low level as shown by the waveform 535, and the transistor 330 is turned off. In certain examples, the drive voltage 325 is at the logic low level as shown by the waveform 525, and the transistor 320 is turned off. In some examples, at time t₆₄, the turning-off control signal 943 (e.g., ZVS_off) is at the logic low level as shown by the waveform 643.

From time t₆₄ to time t₆₅, the drive voltage 325 remains at the logic low level as shown by the waveform 525, and the drive voltage 335 remains at the logic low level as shown by the waveform 535 according to certain embodiments. For example, from time t₆₄ to time t₆₅, the transistor 320 remains turned off, and the transistor 330) also remains turned off. As an example, the time duration from time t₆₄ to time t₆₅ is equal to the second predetermined dead-time duration (e.g., a second predetermined delay) as determined by the dead-time controller 970. In some examples, from time t₆₄ to time t₆₅, through the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ), the current 153 (e.g., I_{Lr}) is used to discharge the parasitic capacitor of the transistor 120 and charge the parasitic capacitor of the transistor 130, and the voltage 127 increases with time. In some examples, from time t₆₄ to time t₆₅, the turning-off control signal 943 (e.g., ZVS_off) remains at the logic low level as shown by the waveform 643.

At time t₆₅, the drive voltage 325 changes from the logic low level to the logic high level as shown by the waveform 525, and the transistor 320 becomes turned on according to some embodiments. For example, at time t₆₅, the turning-on control signal 971 (e.g., up_on) changes from the logic low level to the logic high level, and in response, the drive voltage generator 920 changes the drive voltage 325 from the logic low level to the logic high level in order to turn on the transistor 320. As an example, at time t₆₅, the drive voltage 335 is at the logic low level as shown by the waveform 635, and the transistor 330 is turned off. In certain examples, at time t₆₅, the voltage 327 becomes equal to the voltage 351. As an example, at time t₆₅, the transistor 320 becomes turned on with low-voltage switching and/or zero-voltage switching. In some examples, at time t₆₅, the turning-off control signal 943 (e.g., ZVS_off) is at the logic low level as shown by the waveform 643.

As mentioned above and further emphasized here, the timing diagrams as shown in FIG. 6 are merely examples, which should not unduly limit the scope of the claims. One of ordinary skill in the art would recognize many variations, alternatives, and modifications. For example, at time t₆₂, the voltage 327 becomes close to but is still larger than zero volts, and the transistor 330 becomes turned on with low-voltage switching, wherein the difference between the voltage 327 and the zero volts is small. As an example, at time t₆₅, the voltage 327 becomes close to but is still smaller than the voltage 351, and the transistor 320 becomes turned on with low-voltage switching, wherein the difference between the voltage 327 and the voltage 351 is small.

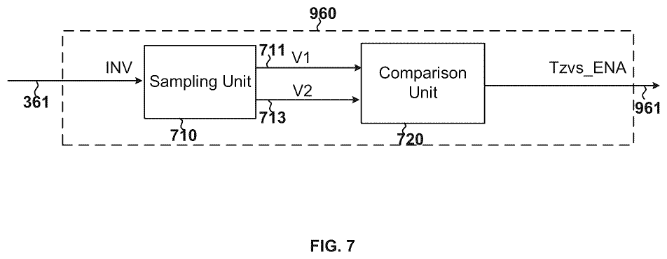

FIG. 7 is a simplified diagram showing the turning-on enablement controller 960 as part of the asymmetrical half-bridge fly back switch-mode power converter 300 as shown in FIG. 4 according to certain embodiments of the present disclosure. This diagram is merely an example, which should not unduly limit the scope of the claims. One of ordinary skill in the art would recognize many variations, alternatives, and modifications. The turning-on enablement controller 960 includes a sampling unit 710 and a comparison unit 720. For example, the sampling unit 710 is implemented using one or more software components, one or more hardware components, and/or one or more combinations of software and hardware components, and/or the sampling unit 710 is implemented in one or more circuits, such as one or more analog circuits and/or one or more digital circuits. As an example, the comparison unit 720 is implemented using one or more software components, one or more hardware components, and/or one or more combinations of software and hardware components, and/or the comparison unit 720 is implemented in one or more circuits, such as one or more analog circuits and/or one or more digital circuits. Although the above has been shown using a selected group of components for the turning-on enablement controller, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In some embodiments, the sampling unit 710 receives the voltage 361 and generates a sampled voltage 711 and a sampled voltage 713 based at least in part on the voltage 361. For example, the sampling unit 710 samples the voltage 361 when the transistor 320 is turned on and the transistor 330 is turned off, and in response generates the sampled voltage 711 (e.g., V1) to represent the voltage 361 when the transistor 320 is turned on and the transistor 330 is turned off. As an example, the sampling unit 710 samples the voltage 361 when the transistor 320 is turned off and the transistor 330 is turned on, and in response generates the sampled voltage 713 (e.g., V2) to represent the voltage 361 when the transistor 320 is turned off and the transistor 330 is turned on.

In certain examples, the sampled voltage 711 (e.g., V1) is directly proportional to the voltage 361 when the transistor 320 is turned on and the transistor 330 is turned off. For example, when the transistor 320 is turned on and the transistor 330 is turned off, the voltage 361 is equal to Vᵢₙ−N×Vₒ, wherein Vin represents the voltage 351. Vₒ represents the output voltage 392, and N represents the turns ratio that is equal to the ratio of the number of turns in the primary winding 310 to the number of turns in the secondary winding 312. As an example, the sampled voltage 711 (e.g., V1) is equal to m₁×(Vᵢₙ−N×Vₒ), wherein m₁ is a predetermined constant. Vin represents the voltage 351. Vₒ represents the output voltage 392, and N represents the turns ratio that is equal to the ratio of the number of turns in the primary winding 310 to the number of turns in the secondary winding 312.

In some examples, the sampled voltage 713 (e.g., V2) is directly proportional to the voltage 361 when the transistor 320 is turned off and the transistor 330 is turned on. For example, when the transistor 320 is turned off and the transistor 330 is turned on, the voltage 361 is equal to N×Vₒ, wherein Vₒ represents the output voltage 392 and N represents the turns ratio that is equal to the ratio of the number of turns in the primary winding 310 to the number of turns in the secondary winding 312. As an example, the sampled voltage 713 (e.g., V2) is equal to m₂×N×Vₒ, wherein m₂ is a predetermined constant, Vₒ represents the output voltage 392, and N represents the turns ratio that is equal to the ratio of the number of turns in the primary winding 310 to the number of turns in the secondary winding 312.

In certain embodiments, the comparison unit 720 receives the sampled voltage 711 and the sampled voltage 713 and generates the turning-on enablement signal 961 (e.g., T_{zvs}_ENA) based at least in part on the sampled voltage 711 and the sampled voltage 713. In some examples, the comparison unit 720 directly compares the sampled voltage 711 and the sampled voltage 713 and generates the turning-on enablement signal 961 (e.g., T_{zvs}_ENA) based at least in part on the comparison. For example, if the sampled voltage 711 is larger than the sampled voltage 713, the turning-on enablement signal 961 (e.g., T_{zvs}_ENA) is at the logic high level. As an example, if the sampled voltage 711 is smaller than the sampled voltage 713, the turning-on enablement signal 961 (e.g., T_{zvs}_ENA) is at the logic low level. In certain examples, the comparison unit 720 converts and then compares the sampled voltage 711 and the sampled voltage 713 and generates the turning-on enablement signal 961 (e.g., T_{zvs}_ENA) based at least in part on the conversion and the comparison. For example, if the sampled voltage 711 is larger than the sampled voltage 713 multiplied by a predetermined constant, the turning-on enablement signal 961 (e.g., T_{zvs}_ENA) is at the logic high level. As an example, if the sampled voltage 711 is smaller than the sampled voltage 713 multiplied by the predetermined constant, the turning-on enablement signal 961 (e.g., T_{zvs}_ENA) is at the logic low level.

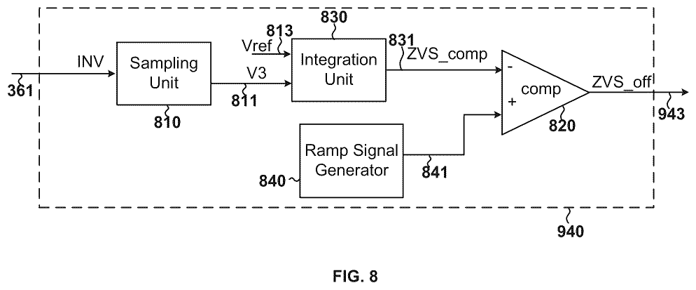

FIG. 8 is a simplified diagram showing the turning-off controller 940 as part of the asymmetrical half-bridge flyback switch-mode power converter 300 as shown in FIG. 4 according to some embodiments of the present disclosure. This diagram is merely an example, which should not unduly limit the scope of the claims. One of ordinary skill in the art would recognize many variations, alternatives, and modifications. The turning-off controller 940 includes a sampling unit 810, an integration unit 830, a ramp signal generator 840, and a comparator 820. For example, the sampling unit 810 is implemented using one or more software components, one or more hardware components, and/or one or more combinations of software and hardware components, and/or the sampling unit 810 is implemented in one or more circuits, such as one or more analog circuits and/or one or more digital circuits. As an example, the integration unit 830 is implemented using one or more software components, one or more hardware components, and/or one or more combinations of software and hardware components, and/or the integration unit 830 is implemented in one or more circuits, such as one or more analog circuits and/or one or more digital circuits. Although the above has been shown using a selected group of components for the turning-off controller, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In certain embodiments, the sampling unit 810 receives the voltage 361 and generates a sampled voltage 811 based at least in part on the voltage 361. In some examples, the sampled voltage 811 (e.g., V3) is received by the integration unit 830, which also receives a reference voltage 813 (e.g., V_{ref}). For example, the integration unit 830 determines a difference between the sampled voltage 811 (e.g., V3) and the reference voltage 813 (e.g., V_{ref}), integrate the difference over time, and generates a compensation signal 831 (e.g., ZVS_comp) to represent the result of the integration. As an example, the reference voltage 813 (e.g., V_{ref}) is equal to 0.2 volts. In some examples, the ramp signal generator 840 generates a ramp signal 841. For example, the ramp signal 841 is a periodic signal. As an example, the ramp signal 841 increases linearly with time at a constant slope. In some embodiments, the comparator 820 receives the compensation signal 831 (e.g., ZVS_comp) and the ramp signal 841 and generates the turning-off control signal 943 (e.g., ZVS_off) based at least in part on the compensation signal 831 (e.g., ZVS_comp) and the ramp signal 841.

In some examples, the sampled voltage 811 (e.g., V3) represents the voltage 327 immediately before the transistor 320 becomes turned on. For example, the sampled voltage 811 (e.g., V3) is directly proportional to the voltage 327 immediately before the transistor 320 becomes turned on. In certain examples, the sampled voltage 811 (e.g., V3) represents a change in the voltage 327 in response to the transistor 320 changing from being turned off to being turned on. For example, the sampled voltage 811 (e.g., V3) is directly proportional to a change in the voltage 327 in response to the transistor 320 changing from being turned off to being turned on. In certain embodiments, the reference voltage 813 is a predetermined constant voltage. In some embodiments, the reference voltage 813 is generated by the sampling unit 810 that samples the voltage 361 when the transistor 320 is turned on.

As shown in FIG. 8, the comparator 820 compares the compensation signal 831 (e.g., ZVS_comp) and the ramp signal 841 and generates the turning-off control signal 943 (e.g., ZVS_off) based at least in part on the comparison according to certain embodiments. For example, when the mode and/or frequency control signal 931 (e.g., DCM_on) changes from the logic low level to the logic high level with the turning-on enablement signal 961 (e.g., T_{zvs}_ENA) at the logic high level, the transistor 330 becomes turned on and the ramp signal 841 starts increasing linearly with time. As an example, when the ramp signal 841 becomes larger than the compensation signal 831 (e.g., ZVS_comp), the comparator 820) changes the turning-off control signal 943 (e.g., ZVS_off) from the logic low level to the logic high level in order to turn off the transistor 330.

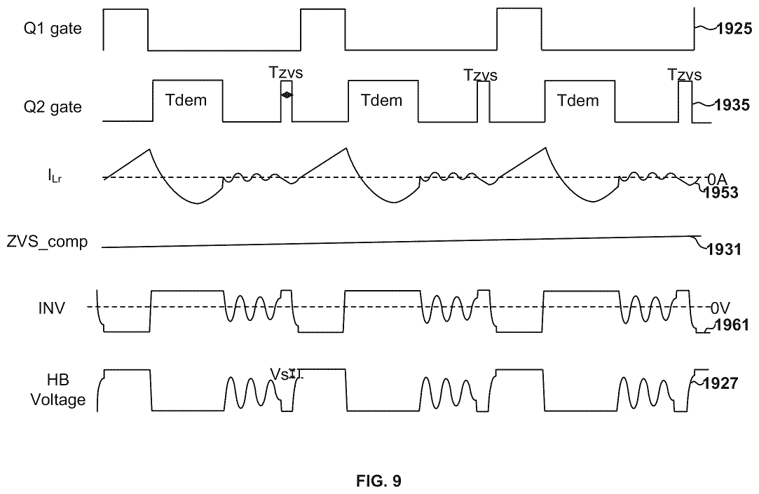

FIG. 9 shows simplified timing diagrams for the asymmetrical half-bridge fly back switch-mode power converter 300 as shown in FIG. 4 and FIG. 8 in the discontinuous conduction mode (DCM) with the mode and/or frequency control signal 931 (e.g., DCM_on) changing from a logic low level to a logic high level when the turning-on enablement signal 961 (e.g., T_{zvs}_ENA) is at a logic high level according to certain embodiment of the present disclosure. These diagrams are merely examples, which should not unduly limit the scope of the claims. One of ordinary skill in the art would recognize many variations, alternatives, and modifications. The waveform 1925 represents the drive voltage 325 as a function of time, the waveform 1935 represents the drive voltage 335 as a function of time, the waveform 1953 represents the current 353 as a function of time, the waveform 1931 represents the compensation signal 831 as a function of time, the waveform 1961 represents the voltage 361 as a function of time, and the waveform 1927 represents the voltage 327 as a function of time.

According to some embodiments, the sampled voltage 811 is larger than the reference voltage 813. For example, the sampled voltage 811 (e.g., V3) represents a change in the voltage 327 in response to the transistor 320 changing from being turned off to being turned on, and the reference voltage 813 is a predetermined constant voltage. As an example, the change in the voltage 327 in response to the transistor 320 changing from being turned off to being turned on is larger than a target value that is directly proportional to the reference voltage 813.

In certain examples, if the sampled voltage 811 is larger than the reference voltage 813, the compensation signal 831 (e.g., ZVS_comp) increases with time as shown by the waveform 1931. For example, after the mode and/or frequency control signal 931 (e.g., DCM_on) changes from the logic low level to the logic high level with the turning-on enablement signal 961 (e.g., T_{zvs}_ENA) at the logic high level, it takes a longer time for the ramp signal 841 to become larger than the compensation signal 831 (e.g., ZVS_comp) if the compensation signal 831 becomes larger.

In some examples, the time duration (e.g., T_{zvs}) from the time when the mode and/or frequency control signal 931 (e.g., DCM_on) changes from the logic low level to the logic high level with the turning-on enablement signal 961 (e.g., T_{zvs}_ENA) at the logic high level to the time when the ramp signal 841 becomes larger than the compensation signal 831 (e.g., ZVS_comp) increases with time as shown by the waveform 1935. For example, when the mode and/or frequency control signal 931 (e.g., DCM_on) changes from the logic low level to the logic high level with the turning-on enablement signal 961 (e.g., T_{zvs}_ENA) at the logic high level, the drive voltage 335 changes from being the logic low level to the logic high level and the transistor 330 becomes turned on. As an example, when the ramp signal 841 becomes larger than the compensation signal 831 (e.g., ZVS_comp), the drive voltage 335 changes from being the logic high level to the logic low level and the transistor 330 becomes turned off.

According to certain embodiments, the time duration (e.g., T_{zvs}) from the time when the mode and/or frequency control signal 931 (e.g., DCM_on) changes from the logic low level to the logic high level with the turning-on enablement signal 961 (e.g., T_{zvs}_ENA) at the logic high level to the time when the ramp signal 841 becomes larger than the compensation signal 831 (e.g., ZVS_comp) increases with time, so the change in the voltage 327 in response to the transistor 320 changing from being turned off to being turned on decreases and becomes closer the target value. For example, if the change in the voltage 327 in response to the transistor 320 changing from being turned off to being turned on becomes equal to the target value, the time duration (e.g., T_{zvs}) stopes changing with time.

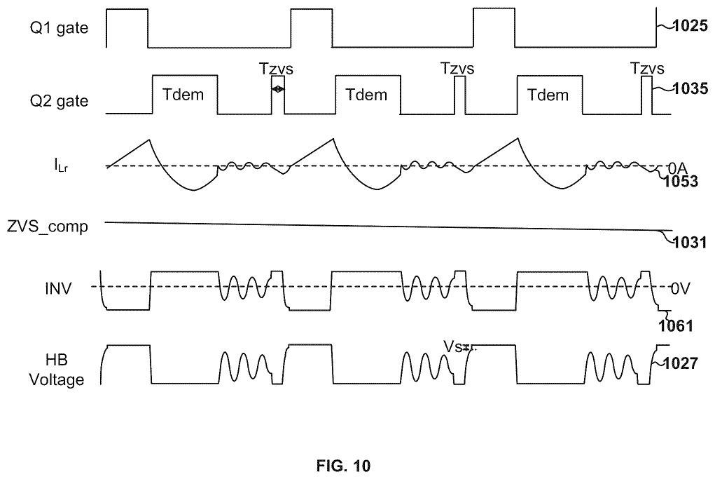

FIG. 10 shows simplified timing diagrams for the asymmetrical half-bridge fly back switch-mode power converter 300 as shown in FIG. 4 and FIG. 8 in the discontinuous conduction mode (DCM) with the mode and/or frequency control signal 931 (e.g., DCM_on) changing from a logic low level to a logic high level when the turning-on enablement signal 961 (e.g., T_{zvs}_ENA) is at a logic high level according to some embodiment of the present disclosure. These diagrams are merely examples, which should not unduly limit the scope of the claims. One of ordinary skill in the art would recognize many variations, alternatives, and modifications. The waveform 1025 represents the drive voltage 325 as a function of time, the waveform 1035 represents the drive voltage 335 as a function of time, the waveform 1053 represents the current 353 as a function of time, the waveform 1031 represents the compensation signal 831 as a function of time, the waveform 1061 represents the voltage 361 as a function of time, and the waveform 1027 represents the voltage 327 as a function of time.

According to certain embodiments, the sampled voltage 811 is smaller than the reference voltage 813. For example, the sampled voltage 811 (e.g., V3) represents a change in the voltage 327 in response to the transistor 320 changing from being turned off to being turned on, and the reference voltage 813 is a predetermined constant voltage. As an example, the change in the voltage 327 in response to the transistor 320 changing from being turned off to being turned on is smaller than a target value that is directly proportional to the reference voltage 813.

In some examples, if the sampled voltage 811 is smaller than the reference voltage 813, the compensation signal 831 (e.g., ZVS_comp) decreases with time as shown by the waveform 1031. For example, after the mode and/or frequency control signal 931 (e.g., DCM_on) changes from the logic low level to the logic high level with the turning-on enablement signal 961 (e.g., T_{zvs}_ENA) at the logic high level, it takes a shorter time for the ramp signal 841 to become larger than the compensation signal 831 (e.g., ZVS_comp) if the compensation signal 831 becomes smaller.

In certain examples, the time duration (e.g., T_{zvs}) from the time when the mode and/or frequency control signal 931 (e.g., DCM_on) changes from the logic low level to the logic high level with the turning-on enablement signal 961 (e.g., T_{zvs}_ENA) at the logic high level to the time when the ramp signal 841 becomes larger than the compensation signal 831 (e.g., ZVS_comp) decreases with time as shown by the waveform 1035. For example, when the mode and/or frequency control signal 931 (e.g., DCM_on) changes from the logic low level to the logic high level with the turning-on enablement signal 961 (e.g., T_{zvs}_ENA) at the logic high level, the drive voltage 335 changes from being the logic low level to the logic high level and the transistor 330 becomes turned on. As an example, when the ramp signal 841 becomes larger than the compensation signal 831 (e.g., ZVS_comp), the drive voltage 335 changes from being the logic high level to the logic low level and the transistor 330 becomes turned off.

According to some embodiments, the time duration (e.g., T_{zvs}) from the time when the mode and/or frequency control signal 931 (e.g., DCM_on) changes from the logic low level to the logic high level with the turning-on enablement signal 961 (e.g., T_{zvs}_ENA) at the logic high level to the time when the ramp signal 841 becomes larger than the compensation signal 831 (e.g., ZVS_comp) decreases with time, so the change in the voltage 327 in response to the transistor 320 changing from being turned off to being turned on increases and becomes closer the target value. For example, if the change in the voltage 327 in response to the transistor 320 changing from being turned off to being turned on becomes equal to the target value, the time duration (e.g., T_{zvs}) stopes changing with time.

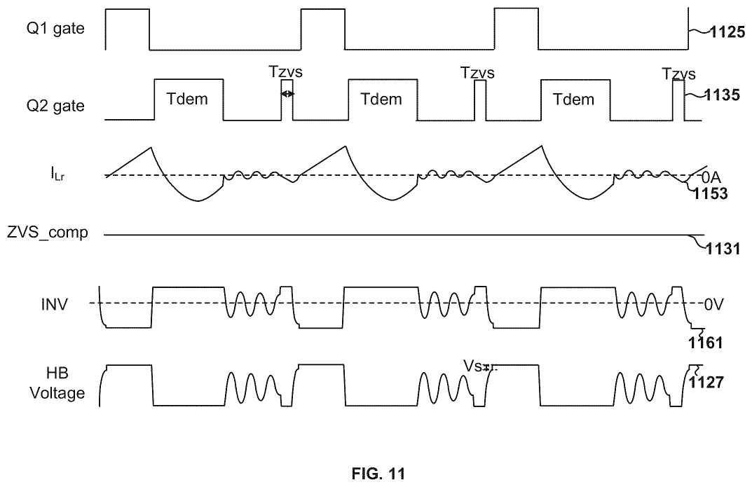

FIG. 11 shows simplified timing diagrams for the asymmetrical half-bridge fly back switch-mode power converter 300 as shown in FIG. 4 and FIG. 8 in the discontinuous conduction mode (DCM) with the mode and/or frequency control signal 931 (e.g., DCM_on) changing from a logic low level to a logic high level when the turning-on enablement signal 961 (e.g., T_{zvs}_ENA) is at a logic high level according to certain embodiment of the present disclosure. These diagrams are merely examples, which should not unduly limit the scope of the claims. One of ordinary skill in the art would recognize many variations, alternatives, and modifications. The waveform 1125 represents the drive voltage 325 as a function of time, the waveform 1135 represents the drive voltage 335 as a function of time, the waveform 1153 represents the current 353 as a function of time, the waveform 1131 represents the compensation signal 831 as a function of time, the waveform 1161 represents the voltage 361 as a function of time, and the waveform 1127 represents the voltage 327 as a function of time.

According to some embodiments, the sampled voltage 811 is equal to the reference voltage 813. For example, the sampled voltage 811 (e.g., V3) represents a change in the voltage 327 in response to the transistor 320 changing from being turned off to being turned on, and the reference voltage 813 is a predetermined constant voltage. As an example, the change in the voltage 327 in response to the transistor 320 changing from being turned off to being turned on is equal to a target value that is directly proportional to the reference voltage 813.

In certain examples, if the sampled voltage 811 is equal to the reference voltage 813, the compensation signal 831 (e.g., ZVS_comp) does not change with time as shown by the waveform 1131. For example, after the mode and/or frequency control signal 931 (e.g., DCM_on) changes from the logic low level to the logic high level with the turning-on enablement signal 961 (e.g., T_{zvs}_ENA) at the logic high level, it takes the same time for the ramp signal 841 to become larger than the compensation signal 831 (e.g., ZVS_comp) if the compensation signal 831 remains constant.

In some examples, the time duration (e.g., T_{zvs}) from the time when the mode and/or frequency control signal 931 (e.g., DCM_on) changes from the logic low level to the logic high level with the turning-on enablement signal 961 (e.g., T_{zvs}_ENA) at the logic high level to the time when the ramp signal 841 becomes larger than the compensation signal 831 (e.g., ZVS_comp) remains constant with time as shown by the waveform 1135. For example, when the mode and/or frequency control signal 931 (e.g., DCM_on) changes from the logic low level to the logic high level with the turning-on enablement signal 961 (e.g., T_{zvs}_ENA) at the logic high level, the drive voltage 335 changes from being the logic low level to the logic high level and the transistor 330 becomes turned on. As an example, when the ramp signal 841 becomes larger than the compensation signal 831 (e.g., ZVS_comp), the drive voltage 335 changes from being the logic high level to the logic low level and the transistor 330 becomes turned off.

According to certain embodiments, the time duration (e.g., T_{zvs}) from the time when the mode and/or frequency control signal 931 (e.g., DCM_on) changes from the logic low level to the logic high level with the turning-on enablement signal 961 (e.g., T_{zvs}_ENA) at the logic high level to the time when the ramp signal 841 becomes larger than the compensation signal 831 (e.g., ZVS_comp) remains constant with time, so the change in the voltage 327 in response to the transistor 320 changing from being turned off to being turned on remains constant and equal to the target value.

As shown in FIG. 9, FIG. 10, and FIG. 11, the asymmetrical half-bridge fly back switch-mode power converter 300 is configured to regulate the change in the voltage 327 in response to the transistor 320 changing from being turned off to being turned on, so that the change in the voltage 327 is equal to a target value that is directly proportional to the reference voltage 813. For example, the target value is not equal to zero. As an example, the target value is equal to 50 volts.

As shown in FIG. 5, at time t₅₅, the drive voltage 335 changes from the logic high level to the logic low level as shown by the waveform 535, and the transistor 330 becomes turned off according to some embodiments. For example, through the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ), the current 353 reaches the current value 555 (e.g., Iₙ_zvs) at time t₅₅, wherein the current value 555 is negative.

In certain examples, in order for the voltage 327 to become equal to the voltage 351 at time t₅₆, the current value 555 needs to satisfy the following equation:

$$\frac{1}{2} \times {C}_{o s s} \times {V}_{i n}^{2} = N \times {V}_{o} \times {V}_{i n} \times {C}_{o s s} + \frac{1}{2} \times {L}_{m} \times {I}_{n \_ ZVS}^{2} \qquad ( Equation 1 )$$

where Cₒₛₛ represents the sum of the capacitance of the parasitic capacitor of the transistor 320 and the capacitance of the parasitic capacitor of the transistor 330. Additionally, Vᵢₙ represents the voltage 351, and Vₒ represents the output voltage 392. Moreover, N represents the turns ratio that is equal to the ratio of the number of turns in the primary winding 310 to the number of turns in the secondary winding 312. Also, Lₘ represents the sum of the primary inductance Lₚ of the inductor 116 and the leakage inductance Lᵣ of the inductor 118, and I_{n_zvs} represents the current value 555.

In some examples, based on Equation 1, in order for the voltage 327 to become equal to the voltage 351 at time t₅₆, the current value 555 is determined as follows:

$${I}_{n \_ ZVS} = - \sqrt{\frac{( {V}_{i n} - 2 \times N \times {V}_{o} ) \times {V}_{i n} \times {C}_{o s s}}{{L}_{m}}} \qquad ( Equation 2 )$$

where I_{n_zvs} represents the current value 555, which is negative. Additionally, Cₒₛₛ represents the sum of the capacitance of the parasitic capacitor of the transistor 320 and the capacitance of the parasitic capacitor of the transistor 330. Moreover, Vᵢₙ represents the voltage 351, and Vₒ represents the output voltage 392. Also, N represents the turns ratio that is equal to the ratio of the number of turns in the primary winding 310 to the number of turns in the secondary winding 312. Additionally, Lₘ represents the sum of the primary inductance Lₚ of the inductor 116 and the leakage inductance Lᵣ of the inductor 118.

According to certain embodiments, the time duration from time t₅₄ to time t₅₅ has the following relationship with the current value 555:

$${T}_{Z V S} = ( - {I}_{n \_ ZVS} ) \times \frac{{L}_{m}}{N \times {V}_{o}} \qquad ( Equation 3 )$$

where T_{zvs} represents the time duration from time t₅₄ to time t₅₅. Additionally, I_{n_ZVS} represents the current value 555, which is negative. Moreover, Vₒ represents the output voltage 392, and N represents the turns ratio that is equal to the ratio of the number of turns in the primary winding 310 to the number of turns in the secondary winding 312. Also, Lₘ represents the sum of the primary inductance Lₚ of the inductor 116 and the leakage inductance Lᵣ of the inductor 118.

In certain examples, based on Equations 2 and 3, in order for the voltage 327 to become equal to the voltage 351 at time t₅₆, the time duration from time t₅₄ to time t₅₅ is approximately determined as follows:

$${T}_{Z V S} \approx α \times \frac{{V}_{i n} - N \times {V}_{o}}{N \times {V}_{o}} \qquad ( Equation 4 )$$

$$α = \sqrt{{C}_{o s s} \times {L}_{m}} \qquad ( Equation 5 )$$

where T_{zvs} represents the time duration from time t₅₄ to time t₅₅. Additionally, Vᵢₙ represents the voltage 351, and Vₒ represents the output voltage 392. Moreover, N represents the turns ratio that is equal to the ratio of the number of turns in the primary winding 310 to the number of turns in the secondary winding 312. Also, Cₒₛₛ represents the sum of the capacitance of the parasitic capacitor of the transistor 320 and the capacitance of the parasitic capacitor of the transistor 330, and Lm represents the sum of the primary inductance Lₚ of the inductor 116 and the leakage inductance Lᵣ of the inductor 118.

In some examples, the resonance period for the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ) from time t₅₃ to time t₅₄ satisfies the following relationship:

$$\frac{{t}_{d}}{2 π} = \sqrt{{C}_{o s s} \times {L}_{m}} \qquad ( Equation 6 )$$

where t_{d} represents the resonance period for the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ) from time t₅₃ to time t₅₄. Additionally, Cₒₛₛ represents the sum of the capacitance of the parasitic capacitor of the transistor 320 and the capacitance of the parasitic capacitor of the transistor 330, and Lm represents the sum of the primary inductance Lₚ of the inductor 116 and the leakage inductance Lᵣ of the inductor 118.

According to some embodiments, based on Equations 4, 5 and 6, in order for the voltage 327 to become equal to the voltage 351 at time t₅₆, the time duration from time t₅₄ to time t₅₅ is approximately determined as follows:

$${T}_{Z V S} \approx \frac{{t}_{d}}{2 π} \times \frac{{V}_{i n} - N \times {V}_{o}}{N \times {V}_{o}} \qquad ( Equation 7 )$$

where T_{zvs} represents the time duration from time t₅₄ to time t₅₅. Additionally, Vᵢₙ represents the voltage 351, and Vₒ represents the output voltage 392. Moreover, N represents the turns ratio that is equal to the ratio of the number of turns in the primary winding 310 to the number of turns in the secondary winding 312. Also, ta represents the resonance period for the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ) from time t₅₃ to time t₅₄.

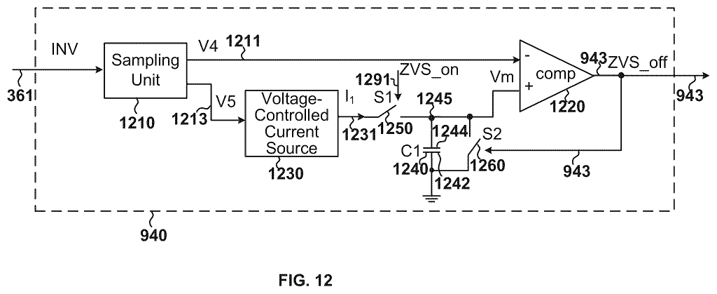

FIG. 12 is a simplified diagram showing the turning-off controller 940 as part of the asymmetrical half-bridge fly back switch-mode power converter 300 as shown in FIG. 4 according to certain embodiments of the present disclosure. This diagram is merely an example, which should not unduly limit the scope of the claims. One of ordinary skill in the art would recognize many variations, alternatives, and modifications. The turning-off controller 940 includes a sampling unit 1210, a voltage-controlled current source 1230, a capacitor 1240, switches 1250 and 1260, and a comparator 1220. For example, the sampling unit 1210 is implemented using one or more software components, one or more hardware components, and/or one or more combinations of software and hardware components, and/or the sampling unit 1210 is implemented in one or more circuits, such as one or more analog circuits and/or one or more digital circuits. Although the above has been shown using a selected group of components for the turning-off controller, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to some embodiments, the sampling unit 1210 receives the voltage 361 and generates a sampled voltage 1211 and a sampled voltage 1213 based at least in part on the voltage 361. For example, the sampling unit 1210 samples the voltage 361 when the transistor 320 is turned on and the transistor 330 is turned off, and in response generates the sampled voltage 1211 (e.g., V4) to represent the voltage 361 when the transistor 320 is turned on and the transistor 330 is turned off. As an example, the sampling unit 1210 samples the voltage 361 when the transistor 320 is turned off and the transistor 330 is turned on, and in response generates the sampled voltage 1213 (e.g., V5) to represent the voltage 361 when the transistor 320 is turned off and the transistor 330 is turned on.

In certain examples, the sampled voltage 1211 (e.g., V4) is directly proportional to the voltage 361 when the transistor 320 is turned on and the transistor 330 is turned off. For example, when the transistor 320 is turned on and the transistor 330 is turned off, the voltage 361 is equal to Vᵢₙ−N×Vₒ, wherein Vᵢₙ represents the voltage 351. Vₒ represents the output voltage 392, and N represents the turns ratio that is equal to the ratio of the number of turns in the primary winding 310 to the number of turns in the secondary winding 312. As an example, the sampled voltage 1211 (e.g., V4) is equal to m₃×(Vᵢₙ−N×Vₒ), wherein m₃ is a predetermined constant. Vᵢₙ represents the voltage 351. Vₒ represents the output voltage 392, and N represents the turns ratio that is equal to the ratio of the number of turns in the primary winding 310 to the number of turns in the secondary winding 312.

In some examples, the sampled voltage 1213 (e.g., V5) is directly proportional to the voltage 361 when the transistor 320 is turned off and the transistor 330 is turned on. For example, when the transistor 320 is turned off and the transistor 330 is turned on the voltage 361 is equal to N×Vₒ, wherein Vₒ represents the output voltage 392 and N represents the turns ratio that is equal to the ratio of the number of turns in the primary winding 310 to the number of turns in the secondary winding 312. As an example, the sampled voltage 713 (e.g., V2) is equal to m₄×N×Vₒ, wherein m₄ is a predetermined constant. Vₒ represents the output voltage 392, and N represents the turns ratio that is equal to the ratio of the number of turns in the primary winding 310 to the number of turns in the secondary winding 312.

According to certain embodiments, the voltage-controlled current source 1230 receives the sampled voltage 1213 (e.g., V5) and generates a current 1231 based at least in part on the sampled voltage 1213 (e.g., V5). For example, the current 1231 (e.g., I₁) is directly proportional to the sampled voltage 1213 (e.g., V5). As an example, the current 1231 is determined as follows:

$${I}_{1} = k \times {V}_{5} \qquad ( Equation 8 )$$

where I₁ represents the current 1231, and V₅ represents the sampled voltage 1213. Additionally, k is a predetermined constant.

In some embodiments, the switch 1250 receives a control signal 1291. For example, if the control signal 1291 (e.g., ZVS_on) is at a logic high level, the switch 1250 is closed. As an example, if the control signal 1291 (e.g., ZVS_on) is at a logic low level, the switch 1250 is open. In certain examples, if the mode and/or frequency control signal 931 (e.g., DCM_on) changes from the logic low level to the logic high level when the turning-on enablement signal 961 (e.g., T_{zvs}_ENA) is at the logic high level, the control signal 1291 (e.g., ZVS_on) changes from the logic low level to the logic high level and the switch 1250 becomes closed. In some examples, after the control signal 1291 (e.g., ZVS_on) changes from the logic low level to the logic high level, the control signal 1291 (e.g., ZVS_on) remains at the logic high level until the turning-off control signal 943 (e.g., ZVS_off) changes from the logic low level to the logic high level. For example, in response to the turning-off control signal 943 (e.g., ZVS_off) changing from the logic low level to the logic high level, the control signal 1291 (e.g., ZVS_on) changes from the logic high level to the logic low level. As an example, at the same time, the turning-off control signal 943 (e.g., ZVS_off) changes from the logic low level to the logic high level and the control signal 1291 (e.g., ZVS_on) changes from the logic high level to the logic low level. In certain embodiments, the switch 1260 receives the turning-off control signal 943 (e.g., ZVS_off). For example, if the turning-off control signal 943 (e.g., ZVS_off) is at a logic high level, the switch 1260 is closed. As an example, if the turning-off control signal 943 (e.g., ZVS_off) is at a logic low level, the switch 1260 is open.

According to some embodiments, the capacitor 1240 includes a capacitor terminal 1242 that is biased to a ground voltage (e.g., 0 volts), and the capacitor 1240 also includes a capacitor terminal 1244 that is biased to a voltage 1245. For example, when the switch 1250 is closed and the switch 1260 is open, the capacitor 1240 is charged by the current 1231 and the voltage 1245 increases with time, until the switch 1260 becomes closed. As an example, when the switch 1260 becomes closed, the switch 1250 becomes open. In certain examples, when the switch 1260 is closed and the switch 1250 is open, the capacitor 1240 is discharged and the voltage 1245 drops to the ground voltage (e.g., 0 volts). For example, at the same time, the switch 1260 becomes closed in response to the turning-off control signal 943 (e.g., ZVS_off) changing from the logic low level to the logic high level, and the switch 1250 becomes open in response to the control signal 1291 (e.g., ZVS_on) changing from the logic high level to the logic low level.

According to certain embodiments, as shown in FIG. 5, at time t₅₄, the capacitor 1240) starts being charged by the current 1231 and the voltage 1245 starts increasing with time. For example, from time t₅₄ to time t₅₅, the capacitor 1240 remains being charged by the current 1231 and the voltage 1245 remains increasing with time. As an example, at time t₅₅, the capacitor 1240 is discharged and the voltage 1245 drops to the ground voltage (e.g., 0) volts).

In some embodiments, the comparator 1220 receives the sampled voltage 1211 (e.g., V4) and the voltage 1245 (e.g., Vₘ) and generates the turning-off control signal 943 (e.g., ZVS_off) based at least in part on the sampled voltage 1211 (e.g., V4) and the voltage 1245 (e.g., Vₘ). For example, if the voltage 1245 (e.g., Vₘ) becomes larger than the turning-off control signal 943 (e.g., ZVS_off), the turning-off control signal 943 (e.g., ZVS_off) changes from the logic low level to the logic high level. As an example, in response to the turning-off control signal 943 (e.g., ZVS_off) changing from the logic low level to the logic high level, the capacitor 1240 is discharged and the voltage 1245 drops to the ground voltage (e.g., 0 volts), causing the turning-off control signal 943 (e.g., ZVS_off) to change from the logic high level to the logic low level.

As shown in FIG. 4, the asymmetrical half-bridge fly back switch-mode power converter 300 includes the turning-off controller 940 as shown in FIG. 12 and the turning-on enablement controller 960 as shown in FIG. 7 according to certain embodiments. In some examples, the turning-off controller 940 as shown in FIG. 12 and the turning-on enablement controller 960 as shown in FIG. 7 share one common sampling unit. For example, the sampling unit 710 and the sampling unit 1210 are one sampling unit. In certain examples, the sampled voltage 711 (e.g., V1) and the sampled voltage 1211 (e.g., V4) are one voltage, and the sampled voltage 713 (e.g., V2) and the sampled voltage 1213 (e.g., V5) are one voltage. For example, the sampled voltage 711 (e.g., V1) is equal to mix(Vᵢₙ−N×Vₒ), and the sampled voltage 1211 (e.g., V4) is equal to m₃×(Vᵢₙ−N×Vₒ), wherein m₁ and m₃ are equal. As an example, the sampled voltage 713 (e.g., V2) is equal to m₂×N×Vₒ, and the sampled voltage 1213 (e.g., V5) is equal to m₄×N×Vₒ, wherein m₂ and m₄ are equal.

In some embodiments, the time duration when the voltage 1245 (e.g., Vₘ) increases from 0 volts to the sampled voltage 1211 (e.g., V4) is determined as follows:

$${T}_{1} = \frac{{C}_{1} \times {m}_{1}}{k \times {m}_{2}} \times \frac{{V}_{i n} - N \times {V}_{o}}{N \times {V}_{o}} \qquad ( Equation 9 )$$

where T₁ represents the time duration when the voltage 1245 (e.g., Vₘ) increases from 0 volts to the sampled voltage 1211 (e.g., V4). Additionally, C₁ represents the capacitance of the capacitor 1240, and k is a predetermined constant as shown in Equation 8. Moreover, m₁ is a predetermined constant, which is equal to m₃. Also, m₂ is a predetermined constant, which is equal to m₄. Additionally, Vᵢₙ represents the voltage 351, and Vₒ represents the output voltage 392. Moreover, N represents the turns ratio that is equal to the ratio of the number of turns in the primary winding 310 to the number of turns in the secondary winding 312.

In certain embodiments, the time duration when the voltage 1245 (e.g., Vₘ) increases from 0 volts to the sampled voltage 1211 (e.g., V4) is the time duration from time t₅₄ to time t₅₅. For example, based on Equations 7 and 9, in order for the voltage 327 to become equal to the voltage 351 at time t₅₆, the following condition needs to be satisfied:

$$\frac{{C}_{1} \times {m}_{1}}{k \times {m}_{2}} = \frac{{t}_{d}}{2 π} \qquad ( Equation 10 )$$

where C₁ represents the capacitance of the capacitor 1240, and k is a predetermined constant as shown in Equation 8. Additionally, m₁ is a predetermined constant, which is equal to m₃. Also, m₂ is a predetermined constant, which is equal to m₄. Moreover, t_{d} represents the resonance period for the resonance of the parasitic capacitor of the transistor 320, the parasitic capacitor of the transistor 330, the inductor 316 (e.g., with the primary inductance Lₚ), and the inductor 318 (e.g., with the leakage inductance Lᵣ) from time t₅₃ to time t₅₄. As an example, if Equation 10 is satisfied, the transistor 320 can be turned on with low-voltage switching and/or zero-voltage switching in order to improve efficiency of the asymmetrical half-bridge fly back switch-mode power converter 300 under a light load condition. In some examples, Equation 10 is used to determine the constant k.

Some embodiments of the present disclosure provide an asymmetrical half-bridge fly back switch-mode power converter (e.g., the asymmetrical half-bridge fly back switch-mode power converter 300) that is configured to control the time duration (e.g., T_{zvs} from time t₅₄ to time t₅₅) when a transistor (e.g., the transistor 330) remains turned on before another transistor (e.g., the transistor 320) becomes turned on, so that in response to the another transistor (e.g., the transistor 320) becoming turned on, the change in the source voltage (e.g., the voltage 327) of the another transistor (e.g., the transistor 320) is equal to a target value. For example, the target value is equal to zero. As an example, the target value is not equal to zero.

According to certain embodiments, a controller for a power converter includes: a first drive signal generator configured to generate a first drive signal to turn off a first transistor at a first time and turn on the first transistor at a second time, the first transistor being configured to receive an input voltage and related to a primary winding coupled to an auxiliary winding and a secondary winding, the secondary winding being related to an output voltage, the second time being later than the first time: a second drive signal generator configured to: generate a second drive signal to turn on a second transistor at a third time, the second transistor being coupled to the first transistor and related to the primary winding, the third time being later than the first time and being earlier than the second time: change the second drive signal to turn off the second transistor at a fourth time, the fourth time being later than the third time and being earlier than the second time; and change the second drive signal to turn on the second transistor at a fifth time, the fifth time being later than the fourth time and being earlier than the second time: a first controller configured to generate a first control signal based at least in part on a first voltage related to the auxiliary winding and output the first control signal to the second drive signal generator: wherein the second drive signal generator is further configured to: in response to the first control signal changing from a first logic level to a second logic level, change the second drive signal to turn off the second transistor at a sixth time, the sixth time being later than the fifth time and being earlier than the second time. For example, the controller is implemented according to at least FIG. 4, FIG. 5, FIG. 8, and/or FIG. 12.

As an example, the first logic level is a logic low level; and the second logic level is a logic high level. For example, the first controller includes: a sampling unit configured to receive the first voltage and generate a sampled voltage based at least in part on the first voltage; an integration unit configured to receive the sampled voltage and a reference voltage and generate a compensation signal based at least in part on the sampled voltage and the reference voltage; a ramp signal generator configured to generate a ramp signal; and a comparator configured to receive the compensation signal and the ramp signal and generate the first control signal based at least in part on the comparison signal and the ramp signal. As an example, the sampling unit is further configured to generate the sampled voltage to represent the first voltage immediately before the first transistor becomes turned on. For example, the sampling unit is further configured to generate the sampled voltage to represent a change in the first voltage in response to the first transistor changing from being turned off to being turned on. As an example, the integration unit is further configured to: determine a difference between the sampled voltage and the reference voltage; and integrate the difference over time to generate the compensation signal. For example, the comparator is further configured to: in response to the ramp signal becoming larger than the compensation signal, change the first control signal from the first logic level to the second logic level.

As an example, the first controller includes: a sampling unit configured to receive the first voltage and generate a first sampled voltage and a second sampled voltage based at least in part on the first voltage; a voltage-controlled current source configured to receive the second sampled voltage and generate a first current based at least in part on the second sampled voltage; a first switch coupled to the voltage-controlled current source and configured to receive a second control signal; a capacitor coupled to the first switch and configured to generate a second voltage; a comparator configured to receive the first sampled voltage and the second voltage and generate the first control signal based at least in part on the first sampled voltage and the second voltage; and a second switch coupled to the first switch and the capacitor and configured to receive the first control signal. For example, the sampling unit is further configured to: generate the first sampled voltage to represent the first voltage when the first transistor is turned on and the second transistor is turned off; and generate the second sampled voltage to represent the first voltage when the first transistor is turned off and the second transistor is turned on. As an example, the voltage-controlled current source is further configured to generate the first current that is equal to the second sampled voltage multiplied by a predetermined constant. For example, the second control signal is configured to turn on the first switch when the second transistor becomes turned on at the fifth time.

As an example, when the first switch is closed and the second switch is open, the capacitor is configured to be charged by the first current to increase the second voltage. For example, the comparator is further configured to: in response to the second voltage becoming larger than the first sampled voltage, change the first control signal from the first logic level to the second logic level to turn off the second transistor at the sixth time. As an example, the first control signal is further configured to close the second switch when the first control signal changes from the first logic level to the second logic level; and the second control signal is further configured to open the second switch when the second control signal changes from the second logic level to the first logic level; wherein the first control signal changes from the first logic level to the second logic level and the second control signal changes from the second logic level to the first logic level at a same time. For example, when the second switch is closed and the first switch is open, the capacitor is configured to be discharged to decrease the second voltage.

According to some embodiments, a controller for a power converter includes: a first drive signal generator configured to generate a first drive signal to turn off a first transistor at a first time and turn on the first transistor at a second time, the first transistor being configured to receive an input voltage and related to a primary winding coupled to an auxiliary winding and a secondary winding, the secondary winding being related to an output voltage, the second time being later than the first time; a second drive signal generator configured to generate a second drive signal to turn on a second transistor at a third time and turn off the second transistor at a fourth time, the second transistor being coupled to the first transistor and related to the primary winding, the third time being later than the first time, the fourth time being later than the third time and being earlier than the second time; an enablement controller configured to generate an enablement control signal based at least in part on a first voltage related to the auxiliary winding and output the enablement control signal to the second drive signal generator; and a first controller configured to generate a first control signal based at least in part on a second voltage related to the output voltage and output the first control signal to the second drive signal generator; wherein the second drive signal generator is further configured to: in response to the first control signal changing from a first logic level to a second logic level when the enablement control signal is at a third logic level, change the second drive signal to turn on the second transistor at a fifth time, the fifth time being later than the fourth time and being earlier than the second time; and in response to the first control signal changing from the first logic level to the second logic level when the enablement control signal is at a fourth logic level, not change the second drive signal so that the second transistor remains being turned off from the fourth time to the second time; wherein: the first logic level and the second logic level are different; and the third logic level and the fourth logic level are different. For example, the controller is implemented according to at least FIG. 4, FIG. 5, FIG. 6, and/or FIG. 7.

As an example, the first logic level is a logic low level; and the second logic level is a logic high level. For example, the third logic level is the logic high level; and the fourth logic level is the logic low level. As an example, the second drive signal generator is further configured to: in response to the second drive signal being changed to turn on the second transistor at the fifth time, change the second drive signal to turn off the second transistor at a sixth time, the sixth time being later than the fifth time and earlier than the second time.

For example, the controller of claim 16 wherein the enablement controller includes: a sampling unit configured to receive the first voltage and generate a first sampled voltage and a second sampled voltage based at least in part on the first voltage; and a comparison unit configured to receive the first sampled voltage and the second sampled voltage and generate the enablement control signal based at least in part on the first sampled voltage and the second sampled voltage. As an example, the sampling unit is further configured to: generate the first sampled voltage to represent the first voltage when the first transistor is turned on and the second transistor is turned off; and generate the second sampled voltage to represent the first voltage when the first transistor is turned off and the second transistor is turned on.

For example, the comparison unit is further configured to: generate the enablement control signal at a logic high level if the first sampled voltage is larger than the second sampled voltage; and generate the enablement control signal at a logic low level if the first sampled voltage is smaller than the second sampled voltage. As an example, the comparison unit is further configured to: generate the enablement control signal at a logic high level if the first sampled voltage is larger than the second sampled voltage multiplied by a predetermined constant; and generate the enablement control signal at a logic low level if the first sampled voltage is smaller than the second sampled voltage multiplied by the predetermined constant.

According to certain embodiments, a method for a power converter includes: generating a first drive signal to turn off a first transistor at a first time, the first transistor being configured to receive an input voltage and related to a primary winding coupled to an auxiliary winding and a secondary winding, the secondary winding being related to an output voltage; changing the first drive signal to turn on the first transistor at a second time, the second time being later than the first time; generating a second drive signal to turn on a second transistor at a third time, the second transistor being coupled to the first transistor and related to the primary winding, the third time being later than the first time and being earlier than the second time; changing the second drive signal to turn off the second transistor at a fourth time, the fourth time being later than the third time and being earlier than the second time; changing the second drive signal to turn on the second transistor at a fifth time, the fifth time being later than the fourth time and being earlier than the second time; generating a first control signal based at least in part on a first voltage related to the auxiliary winding; and in response to the first control signal changing from a first logic level to a second logic level, changing the second drive signal to turn off the second transistor at a sixth time, the sixth time being later than the fifth time and being earlier than the second time. For example, the method is implemented according to at least FIG. 4, FIG. 5, FIG. 8, and/or FIG. 12.

According to some embodiments, a method for a power converter includes: generating a first drive signal to turn off a first transistor at a first time, the first transistor being configured to receive an input voltage and related to a primary winding coupled to an auxiliary winding and a secondary winding, the secondary winding being related to an output voltage; changing the first drive signal to turn on the first transistor at a second time, the second time being later than the first time; generating a second drive signal to turn on a second transistor at a third time, the second transistor being coupled to the first transistor and related to the primary winding, the third time being later than the first time and being earlier than the second time; changing the second drive signal to turn off the second transistor at a fourth time, the fourth time being later than the third time and being earlier than the second time; generating an enablement control signal based at least in part on a first voltage related to the auxiliary winding: generating a first control signal based at least in part on a second voltage related to the output voltage; in response to the first control signal changing from a first logic level to a second logic level when the enablement control signal is at a third logic level, changing the second drive signal to turn on the second transistor at a fifth time, the fifth time being later than the fourth time and being earlier than the second time; and in response to the first control signal changing from the first logic level to the second logic level when the enablement control signal is at a fourth logic level, not changing the second drive signal so that the second transistor remains being turned off from the fourth time to the second time; wherein: the first logic level and the second logic level are different; and the third logic level and the fourth logic level are different. For example, the method is implemented according to at least FIG. 4, FIG. 5, FIG. 6, and/or FIG. 7.

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, various embodiments and/or examples of the present disclosure can be combined.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

What is claimed is:

1. A controller for a power converter, the controller comprising:
a first drive signal generator configured to generate a first drive signal to turn off a first transistor at a first time and turn on the first transistor at a second time, the first transistor being configured to receive an input voltage and related to a primary winding coupled to an auxiliary winding and a secondary winding, the secondary winding being related to an output voltage, the second time being later than the first time;
a second drive signal generator configured to:
generate a second drive signal to turn on a second transistor at a third time, the second transistor being coupled to the first transistor and related to the primary winding, the third time being later than the first time and being earlier than the second time;
change the second drive signal to turn off the second transistor at a fourth time, the fourth time being later than the third time and being earlier than the second time; and
change the second drive signal to turn on the second transistor at a fifth time, the fifth time being later than the fourth time and being earlier than the second time;
a first controller configured to generate a first control signal based at least in part on a first voltage related to the auxiliary winding and output the first control signal to the second drive signal generator:
wherein the second drive signal generator is further configured to:
in response to the first control signal changing from a first logic level to a second logic level, change the second drive signal to turn off the second transistor at a sixth time, the sixth time being later than the fifth time and being earlier than the second time.

2. The controller of claim 1 wherein:
the first logic level is a logic low level; and
the second logic level is a logic high level.

3. The controller of claim 1 wherein the first controller includes:
a sampling unit configured to receive the first voltage and generate a sampled voltage based at least in part on the first voltage;
an integration unit configured to receive the sampled voltage and a reference voltage and generate a compensation signal based at least in part on the sampled voltage and the reference voltage;
a ramp signal generator configured to generate a ramp signal; and
a comparator configured to receive the compensation signal and the ramp signal and generate the first control signal based at least in part on the comparison signal and the ramp signal.

4. The controller of claim 3 wherein the sampling unit is further configured to generate the sampled voltage to represent the first voltage immediately before the first transistor becomes turned on.

5. The controller of claim 3 wherein the sampling unit is further configured to generate the sampled voltage to represent a change in the first voltage in response to the first transistor changing from being turned off to being turned on.

6. The controller of claim 3 wherein the integration unit is further configured to:
determine a difference between the sampled voltage and the reference voltage; and
integrate the difference over time to generate the compensation signal.

7. The controller of claim 3 wherein the comparator is further configured to:
in response to the ramp signal becoming larger than the compensation signal, change the first control signal from the first logic level to the second logic level.

8. The controller of claim 1 wherein the first controller includes:
a sampling unit configured to receive the first voltage and generate a first sampled voltage and a second sampled voltage based at least in part on the first voltage;
a voltage-controlled current source configured to receive the second sampled voltage and generate a first current based at least in part on the second sampled voltage;
a first switch coupled to the voltage-controlled current source and configured to receive a second control signal;
a capacitor coupled to the first switch and configured to generate a second voltage;
a comparator configured to receive the first sampled voltage and the second voltage and generate the first control signal based at least in part on the first sampled voltage and the second voltage; and
a second switch coupled to the first switch and the capacitor and configured to receive the first control signal.

9. The controller of claim 8 wherein the sampling unit is further configured to:
generate the first sampled voltage to represent the first voltage when the first transistor is turned on and the second transistor is turned off; and
generate the second sampled voltage to represent the first voltage when the first transistor is turned off and the second transistor is turned on.

10. The controller of claim 8 wherein the voltage-controlled current source is further configured to generate the first current that is equal to the second sampled voltage multiplied by a predetermined constant.

11. The controller of claim 8 wherein the second control signal is configured to turn on the first switch when the second transistor becomes turned on at the fifth time.

12. The controller of claim 8 wherein:
when the first switch is closed and the second switch is open, the capacitor is configured to be charged by the first current to increase the second voltage.

13. The controller of claim 12 wherein the comparator is further configured to:
in response to the second voltage becoming larger than the first sampled voltage, change the first control signal from the first logic level to the second logic level to turn off the second transistor at the sixth time.

14. The controller of claim 13 wherein:
the first control signal is further configured to close the second switch when the first control signal changes from the first logic level to the second logic level; and
the second control signal is further configured to open the second switch when the second control signal changes from the second logic level to the first logic level;
wherein the first control signal changes from the first logic level to the second logic level and the second control signal changes from the second logic level to the first logic level at a same time.

15. The controller of claim 14 wherein:
when the second switch is closed and the first switch is open, the capacitor is configured to be discharged to decrease the second voltage.

16. A controller for a power converter, the controller comprising:
a first drive signal generator configured to generate a first drive signal to turn off a first transistor at a first time and turn on the first transistor at a second time, the first transistor being configured to receive an input voltage and related to a primary winding coupled to an auxiliary winding and a secondary winding, the secondary winding being related to an output voltage, the second time being later than the first time;
a second drive signal generator configured to generate a second drive signal to turn on a second transistor at a third time and turn off the second transistor at a fourth time, the second transistor being coupled to the first transistor and related to the primary winding, the third time being later than the first time, the fourth time being later than the third time and being earlier than the second time;
an enablement controller configured to generate an enablement control signal based at least in part on a first voltage related to the auxiliary winding and output the enablement control signal to the second drive signal generator; and
a first controller configured to generate a first control signal based at least in part on a second voltage related to the output voltage and output the first control signal to the second drive signal generator:
wherein the second drive signal generator is further configured to:
in response to the first control signal changing from a first logic level to a second logic level when the enablement control signal is at a third logic level, change the second drive signal to turn on the second transistor at a fifth time, the fifth time being later than the fourth time and being earlier than the second time; and
in response to the first control signal changing from the first logic level to the second logic level when the enablement control signal is at a fourth logic level, not change the second drive signal so that the second transistor remains being turned off from the fourth time to the second time;
wherein:
the first logic level and the second logic level are different; and
the third logic level and the fourth logic level are different.

17. The controller of claim 16 wherein:
the first logic level is a logic low level; and
the second logic level is a logic high level.

18. The controller of claim 17 wherein:
the third logic level is the logic high level; and
the fourth logic level is the logic low level.

19. The controller of claim 16 wherein the second drive signal generator is further configured to:
in response to the second drive signal being changed to turn on the second transistor at the fifth time, change the second drive signal to turn off the second transistor at a sixth time, the sixth time being later than the fifth time and earlier than the second time.

20. The controller of claim 16 wherein the enablement controller includes:
a sampling unit configured to receive the first voltage and generate a first sampled voltage and a second sampled voltage based at least in part on the first voltage; and
a comparison unit configured to receive the first sampled voltage and the second sampled voltage and generate the enablement control signal based at least in part on the first sampled voltage and the second sampled voltage.

21. The controller of claim 20 wherein the sampling unit is further configured to:
generate the first sampled voltage to represent the first voltage when the first transistor is turned on and the second transistor is turned off; and
generate the second sampled voltage to represent the first voltage when the first transistor is turned off and the second transistor is turned on.

22. The controller of claim 20 wherein the comparison unit is further configured to:
generate the enablement control signal at a logic high level if the first sampled voltage is larger than the second sampled voltage; and
generate the enablement control signal at a logic low level if the first sampled voltage is smaller than the second sampled voltage.

23. The controller of claim 20 wherein the comparison unit is further configured to:
generate the enablement control signal at a logic high level if the first sampled voltage is larger than the second sampled voltage multiplied by a predetermined constant; and
generate the enablement control signal at a logic low level if the first sampled voltage is smaller than the second sampled voltage multiplied by the predetermined constant.

24. A method for a power converter, the method comprising:
generating a first drive signal to turn off a first transistor at a first time, the first transistor being configured to receive an input voltage and related to a primary winding coupled to an auxiliary winding and a secondary winding, the secondary winding being related to an output voltage;
changing the first drive signal to turn on the first transistor at a second time, the second time being later than the first time;
generating a second drive signal to turn on a second transistor at a third time, the second transistor being coupled to the first transistor and related to the primary winding, the third time being later than the first time and being earlier than the second time;
changing the second drive signal to turn off the second transistor at a fourth time, the fourth time being later than the third time and being earlier than the second time;
changing the second drive signal to turn on the second transistor at a fifth time, the fifth time being later than the fourth time and being earlier than the second time;
generating a first control signal based at least in part on a first voltage related to the auxiliary winding; and
in response to the first control signal changing from a first logic level to a second logic level, changing the second drive signal to turn off the second transistor at a sixth time, the sixth time being later than the fifth time and being earlier than the second time.

25. A method for a power converter, the method comprising:
generating a first drive signal to turn off a first transistor at a first time, the first transistor being configured to receive an input voltage and related to a primary winding coupled to an auxiliary winding and a secondary winding, the secondary winding being related to an output voltage;
changing the first drive signal to turn on the first transistor at a second time, the second time being later than the first time;
generating a second drive signal to turn on a second transistor at a third time, the second transistor being coupled to the first transistor and related to the primary winding, the third time being later than the first time and being earlier than the second time;
changing the second drive signal to turn off the second transistor at a fourth time, the fourth time being later than the third time and being earlier than the second time;
generating an enablement control signal based at least in part on a first voltage related to the auxiliary winding:
generating a first control signal based at least in part on a second voltage related to the output voltage;
in response to the first control signal changing from a first logic level to a second logic level when the enablement control signal is at a third logic level, changing the second drive signal to turn on the second transistor at a fifth time, the fifth time being later than the fourth time and being earlier than the second time; and
in response to the first control signal changing from the first logic level to the second logic level when the enablement control signal is at a fourth logic level, not changing the second drive signal so that the second transistor remains being turned off from the fourth time to the second time;
wherein:
the first logic level and the second logic level are different; and
the third logic level and the fourth logic level are different.
